(19) United States
(12) Patent Application Publication
(10) Pub. No.: US 2025/0015541 A1
(43) Pub. Date: Jan. 9, 2025

(54) CONNECTOR AND CONNECTOR SYSTEM

(71) Applicant: I-PEX Inc., Kyoto-shi (JP)

(72) Inventor: Sho SUZUKI, Tokyo (JP)

(21) Appl. No.: 18/894,571

(22) Filed: Sep. 24, 2024

Related U.S. Application Data
(63) Continuation of application No. PCT/JP2023/012556, filed on Mar. 28, 2023.

(30) Foreign Application Priority Data
Mar. 31, 2022 (JP) 2022-060099

(51) Int. Cl. H01R 13/6585; H01R 12/71

(52) U.S. Cl. CPC H01R 13/6585; H01R 12/716

(57) ABSTRACT

A connector is configured to be mounted on a circuit board and to be connected to a mate connector along an axis perpendicular to the circuit board. The connector includes: a conductive inner surrounding wall surrounding the axis; a conductive outer surrounding wall surrounding the axis and the inner surrounding wall; a plurality of conductive inner contacts disposed in the inner surrounding wall, configured to be electrically connected to the circuit board, and configured to be respectively in contact with a plurality of mate inner contacts of the mate connector; and one or more conductive outer contacts disposed between the inner surrounding wall and the outer surrounding wall, configured to be electrically connected to the circuit board, and configured to be respectively in contact with one or more mate outer contacts of the mate connector.

### CROSS-REFERENCE TO RELATED APPLICATIONS

This application is a continuation application of PCT Application No. PCT/JP2023/012556, filed on Mar. 28, 2023, which claims the benefit of priority from Japanese Patent Application No. 2022-060099, filed on Mar. 31, 2022. The entire contents of the above listed PCT and priority applications are incorporated herein by reference.

### BACKGROUND

### Field

The present disclosure relates to a connector and a connector system.

### Description of the Related Art

Japanese Unexamined Patent Publication No. 2020-102462 discloses an electric connector set including a first connector and a second connector. The first connector includes a first connection terminal, a first radio frequency connection terminal that includes a first mounting portion and transmits a radio frequency signal, and a first external ground member that surrounds the first radio frequency connection terminal. The second connector includes a second connection terminal, a second radio frequency connection terminal that includes a second mounting portion, and a second external ground member that surrounds the second radio frequency connection terminal. When the first connector and the second connector are fitted to each other, the second external ground member is positioned inside the first external ground member, the first connection terminal and the second connection terminal are positioned outside the first external ground member, and the second external ground member is circumferentially closed so as to surround the outer shape of the first radio frequency connection terminal and the outer shape of the second radio frequency connection terminal when viewed from the insertion/extraction direction.

### SUMMARY

Disclosed herein is a connector configured to be mounted on a circuit board and to be connected to a mate connector along an axis perpendicular to the circuit board. The connector may include: a conductive inner surrounding wall surrounding the axis; a conductive outer surrounding wall surrounding the axis and the inner surrounding wall; a plurality of conductive inner contacts disposed in the inner surrounding wall, configured to be electrically connected to the circuit board, and configured to be respectively in contact with a plurality of mate inner contacts of the mate connector; and one or more conductive outer contacts disposed between the inner surrounding wall and the outer surrounding wall, configured to be electrically connected to the circuit board, and configured to be respectively in contact with one or more mate outer contacts of the mate connector.

Additionally, a connector system is disclosed herein. The connector system may include: a mate connector configured to be mounted on a mate circuit board; and a connector configured to be mounted on a circuit board and configured to be connected to the mate connector along an axis perpendicular to the mate circuit board and the circuit board. The mate connector includes: a conductive mate inner surrounding wall surrounding the axis; a conductive mate outer surrounding wall surrounding the axis and the mate inner surrounding wall; a plurality of conductive mate inner contacts disposed in the mate inner surrounding wall and configured to be electrically connected to the mate circuit board; and one or more conductive mate outer contacts disposed between the mate inner surrounding wall and the mate outer surrounding wall and configured to be electrically connected to the mate circuit board. The connector includes: a conductive inner surrounding wall surrounding the axis and configured to fit to the mate inner surrounding wall; a conductive outer surrounding wall surrounding the axis and the inner surrounding wall and configured to fit to the mate outer surrounding wall; a plurality of conductive inner contacts disposed in the inner surrounding wall, configured to be electrically connected to the circuit board, and configured to be respectively in contact with the plurality of mate inner contacts; and one or more outer contacts disposed between the inner surrounding wall and the outer surrounding wall, configured to be electrically connected to the circuit board, and configured to be respectively in contact with the one or more mate outer contacts.

### BRIEF DESCRIPTION OF THE DRAWINGS

FIG. 1 is a perspective view illustrating a configuration of a connector system.

FIG. 2 is a perspective view illustrating a configuration of a receptacle connector.

FIG. 3 is an exploded perspective view of the receptacle connector of FIG. 2.

FIG. 4 is a perspective view of a shell of FIG. 3 seen from an opposite direction.

FIG. 5 is a cross-sectional view taken along line V-V in FIG. 2.

FIG. 6 is a cross-sectional view taken along line VI-VI in FIG. 2.

FIG. 7 is a cross-sectional view taken along line VII-VII in FIG. 2.

FIG. 8 is a cross-sectional view taken along line VIII-VIII in FIG. 2.

FIG. 9 is a perspective view of an inner housing of FIG. 3.

FIG. 10 is a perspective view of an outer housing of FIG. 3.

FIG. 11 is a schematic view illustrating a conductive pattern of a circuit board.

FIG. 12 is a perspective view illustrating a configuration of a plug connector.

FIG. 13 is an exploded perspective view of the plug connector of FIG. 12.

FIG. 14 is a perspective view of a shell of FIG. 13.

FIG. 15 is a cross-sectional view taken along line XV-XV in FIG. 12.

FIG. 16 is a cross-sectional view taken along line XVI-XVI in FIG. 12.

FIG. 17 is a cross-sectional view taken along line XVII-XVII in FIG. 12.

FIG. 18 is a cross-sectional view taken along line XVIII-XVIII in FIG. 12.

FIG. 19 is a perspective view of an inner housing of FIG. 13.

FIG. 20 is a perspective view of an outer housing of FIG. 13.

FIG. 21 is a schematic view illustrating a conductive pattern of a circuit board.

FIG. 22 is a cross-sectional view of the plug connector mated with the receptacle connector.

FIG. 23 is a cross-sectional view of the plug connector mated with the receptacle connector.

### DETAILED DESCRIPTION

In the following description, with reference to the drawings, the same reference numbers are assigned to the same components or to similar components having the same function, and overlapping description is omitted.

### Connector System

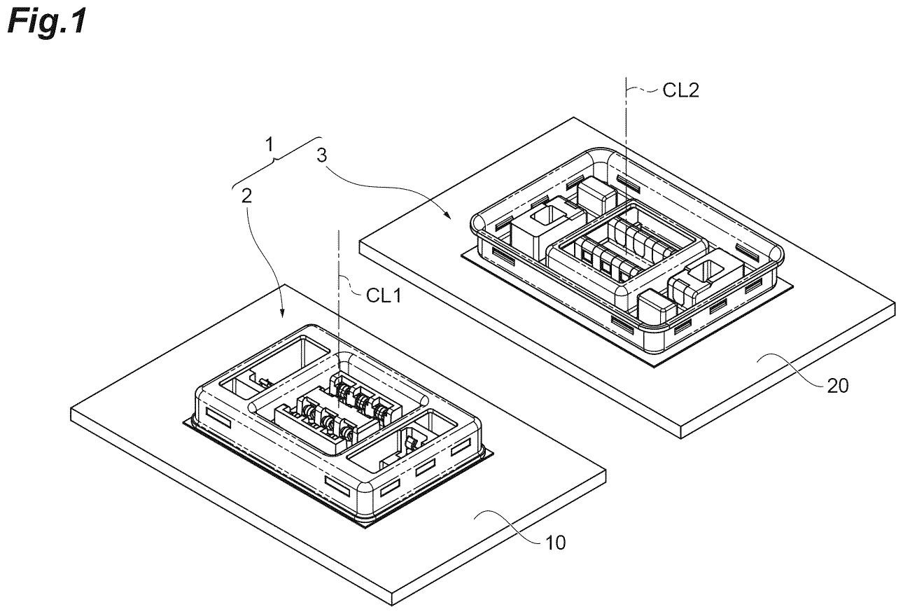

FIG. 1 is a perspective view illustrating a configuration of a connector system 1. The connector system 1 illustrated in FIG. 1 is used for connection between circuit boards in communication terminals such as smartphones or tablet computers. The connector system 1 is not limited to communication terminals and can be applied to various electrical devices.

The connector system 1 includes a receptacle connector 2 and a plug connector 3. The receptacle connector 2 is mounted on a circuit board 10 and connected to the plug connector 3 along an axis CL1 perpendicular to the circuit board 10. The plug connector 3 is mounted on a circuit board 20 and connected to the receptacle connector 2 along an axis CL2 perpendicular to the circuit board 20. The connection between the receptacle connector 2 and the plug connector 3 provides an electrical connection between the circuit board 10 and the circuit board 20. Hereinafter, example configurations of the receptacle connector 2 and the plug connector 3 will be described in detail.

### Receptacle Connector

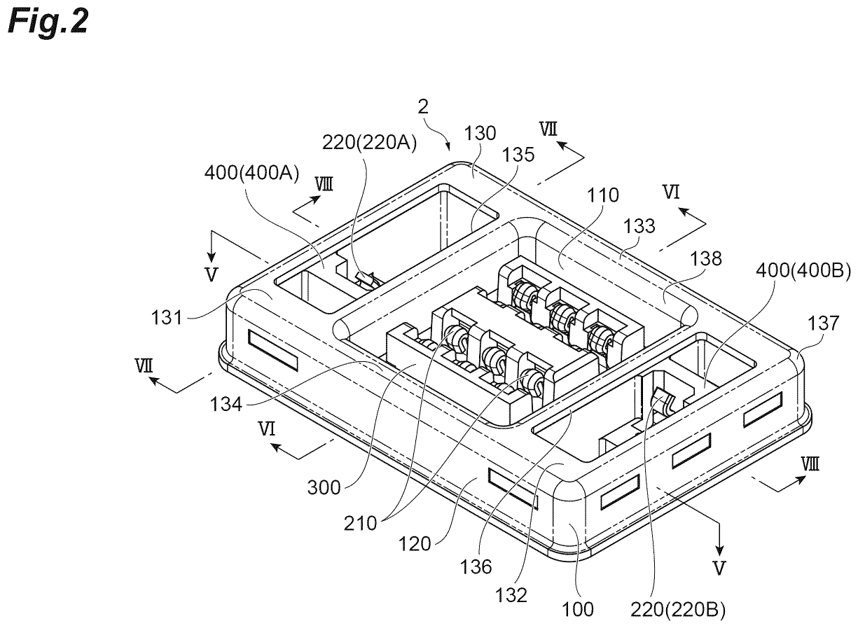

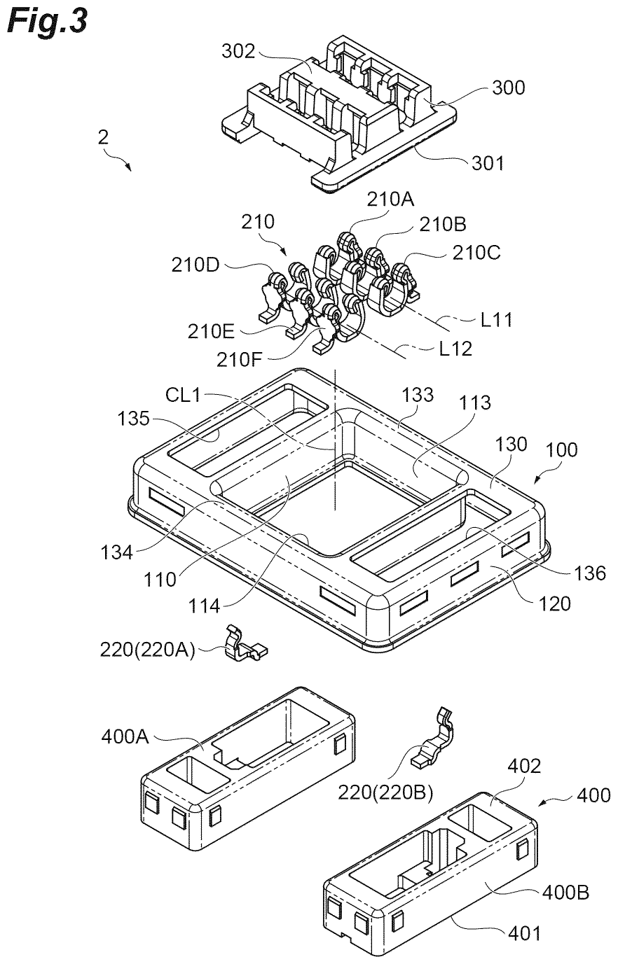

FIG. 2 is a perspective view illustrating the configuration of the receptacle connector 2. FIG. 3 is an exploded perspective view of the receptacle connector 2. As illustrated in FIGS. 2 and 3, the receptacle connector 2 includes a shell 100, a plurality of inner contacts 210, one or more outer contacts 220, an inner housing 300, and an outer housing 400.

The shell 100 includes an inner surrounding wall 110 and an outer surrounding wall 120. The shell 100 is formed of a metallic sheet material or the like, and has conductivity. The inner surrounding wall 110 surrounds the axis CL1. The outer surrounding wall 120 surrounds the axis CL1 and the inner surrounding wall 110.

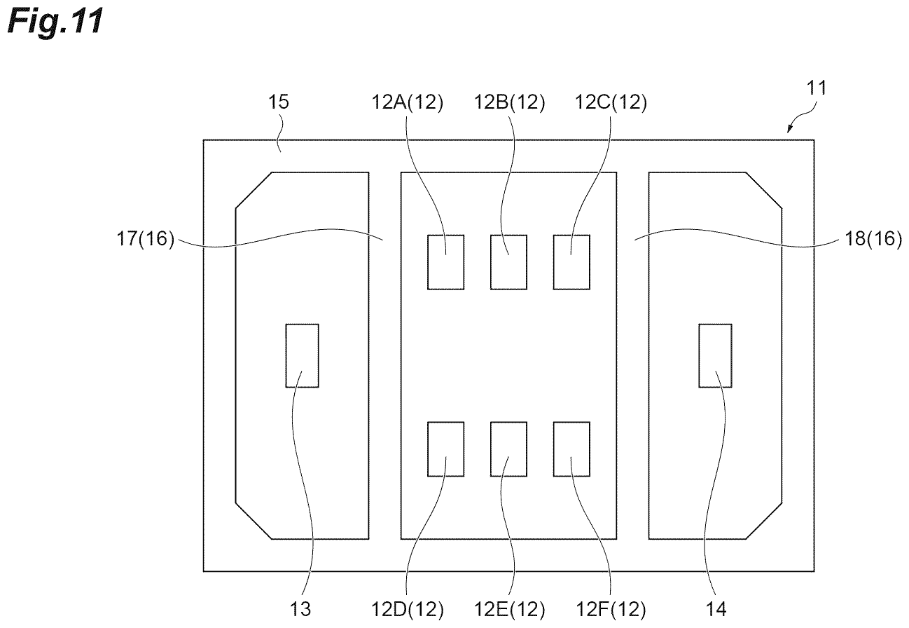

The plurality of inner contacts 210 are disposed within the inner surrounding wall 110 and are electrically connected to the circuit board 10. Each of the plurality of inner contacts 210 is formed of a metallic sheet material or the like, and has conductivity. For example, the plurality of inner contacts 210 are electrically connected to a plurality of conductive patterns (for example, a plurality of inner signal patterns 12 described below) formed on a surface of the circuit board 10, respectively (see FIG. 11). When the receptacle connector 2 is connected to the plug connector 3, the plurality of inner contacts 210 come into contact with a plurality of inner contacts 610 of the plug connector 3, respectively.

The one or more outer contacts 220 are disposed between the inner surrounding wall 110 and the outer surrounding wall 120 and are electrically connected to the circuit board 10. Each of the one or more outer contacts 220 is formed of a metallic sheet material or the like, and has conductivity. For example, the one or more outer contacts 220 are electrically connected to one or more conductive patterns (for example, a first outer signal pattern 13 and a second outer signal pattern 14, which will be described below) formed on the circuit board 10 (see FIG. 11). When the receptacle connector 2 is connected to the plug connector 3, the one or more outer contacts 220 come into contact with the one or more outer contacts 620 of the plug connector 3, respectively.

In one example, the one or more outer contacts 220 include a first outer contact 220A and a second outer contact 220B, and the inner surrounding wall 110 is located between the first outer contact 220A and the second outer contact 220B. The first outer contact 220A is electrically connected to the first outer signal pattern 13, described below, and the second outer contact 220B is electrically connected to the second outer signal pattern 14 described below. When the receptacle connector 2 is connected to the plug connector 3, the first outer contact 220A comes into contact with a first outer contact 620A of the plug connector 3 and the second outer contact 220B comes into contact with a second outer contact 620B of the plug connector 3.

The inner housing 300 holds the plurality of inner contacts 210 within the inner surrounding wall 110. The inner housing 300 is formed of a resin material or the like and has an insulating property. By the inner housing 300, the plurality of inner contacts 210 are insulated from each other, and each of the plurality of inner contacts 210 and the inner surrounding wall 110 are insulated from each other. The inner housing 300 includes a facing surface 301 facing the circuit board 10 and an opposite surface 302 on the opposite side of the facing surface 301.

The outer housing 400 holds the one or more outer contacts 220 between the outer surrounding wall 120 and the inner surrounding wall 110. The outer housing 400 is formed of a resin material or the like and has an insulating property. The outer housing 400 isolates the one or more outer contacts 220 (for example, the first outer contact 220A and the second outer contact 220B) from each other, isolates each of the one or more outer contacts 220 from the inner surrounding wall 110, and isolates each of the one or more outer contacts 220 from the outer surrounding wall 120.

The outer housing 400 is formed separately from the inner housing 300. Two objects being formed separately means that the two objects are formed such that they are not directly fixed to each other. The same applies to the following. For example, the inner housing 300 and the outer housing 400 are fixed to the shell 100 in a state of being divided by the inner surrounding wall 110. Without the shell 100, the inner housing 300 and the outer housing 400 are not secured to each other.

The outer housing 400 may include a first outer housing 400A and a second outer housing 400B. The first outer housing 400A is formed separately from the inner housing 300 and holds the first outer contact 220A. The first outer housing 400A includes a facing surface 401 facing the circuit board 10 and an opposite surface 402 on the opposite side of the facing surface 401.

The second outer housing 400B is formed separately from both the inner housing 300 and the first outer housing 400A and holds the second outer contact 220B. When viewed from a direction along the axis CL1, the inner housing 300 is located between the first outer housing 400A and the second outer housing 400B. For example, the first outer housing 400A and the inner housing 300 are divided by the inner surrounding wall 110, and the second outer housing 400B and the inner housing 300 are divided by the inner surrounding wall 110. Accordingly, the first outer housing 400A and the second outer housing 400B are divided by the inner surrounding wall 110. Similarly to the first outer housing 400A, the second outer housing 400B includes a facing surface 401 facing the circuit board 10 and an opposite surface 402 on the opposite side of the facing surface 401.

Hereinafter, configurations of the shell 100, the inner contact 210, the first outer contact 220A, the second outer contact 220B, the inner housing 300, the first outer housing 400A, and the second outer housing 400B will be described in more detail with reference to other drawings.

### Shell

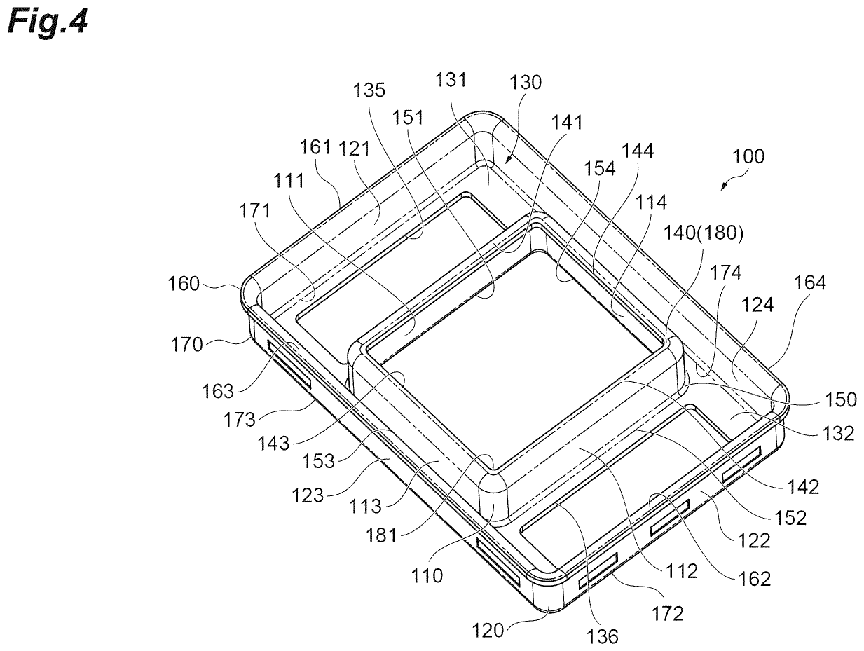

FIG. 4 is a perspective view of the shell 100 illustrated in FIG. 3 seen from the opposite direction. As illustrated in FIG. 4, each of the inner surrounding wall 110 and the outer surrounding wall 120 may be seamlessly continuous over the entire circumference.

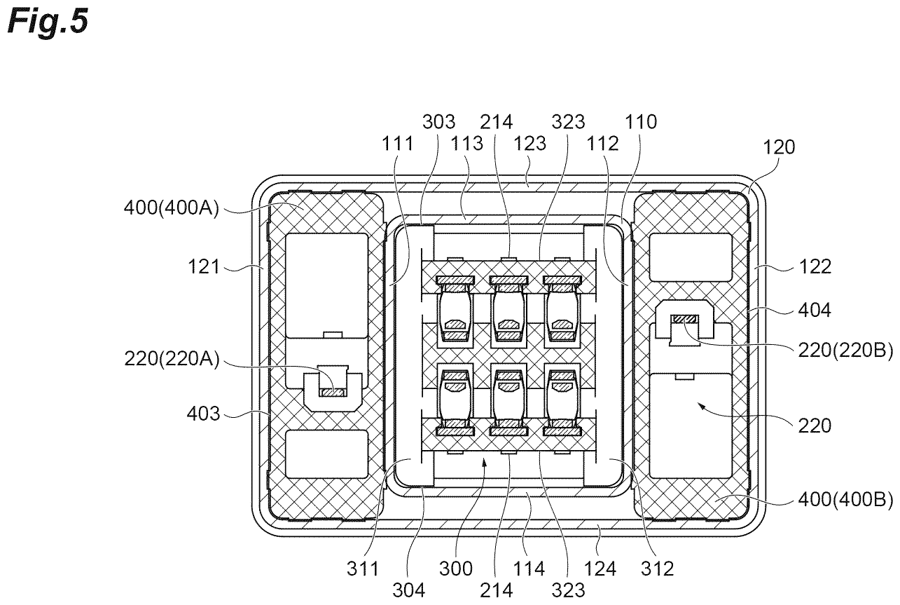

As illustrated in FIG. 5, the inner surrounding wall 110 has a rectangular shape when viewed from the direction along the axis CL1, and includes a first partition wall 111 and a second partition wall 112 which are parallel to each other, and a first inner side wall 113 and a second inner side wall 114 which are parallel to each other. The rectangular shape includes a rectangular shape with rounded corners. The same applies to the following. The first partition wall 111 is located between the inner housing 300 and the first outer housing 400A, and the second partition wall 112 is located between the inner housing 300 and the second outer housing 400B. The first inner side wall 113 and the second inner side wall 114 each couple the first partition wall 111 to the second partition wall 112.

The inner housing 300 includes a first side 303 facing the first inner side wall 113 and a second side 304 facing the second inner side wall 114. The first side 303 and the second side 304 are parallel to each other, and each of the first side 303 and the second side 304 lies along a plane that intersects (for example, is orthogonal to) both the circuit board 10 and the first partition wall 111. Each of the first partition wall 111 and the second partition wall 112 extends from the first side 303 to the second side 304 to couple the first inner side wall 113 to the second inner side wall 114.

The outer surrounding wall 120 has a rectangular shape when viewed from a direction along the axis CL1 and includes a first outer end wall 121 and a second outer end wall 122 that are parallel to each other and a first outer side wall 123 and a second outer side wall 124 that are parallel to each other. The first outer contact 220A and the first outer housing 400A are located between the first outer end wall 121 and the inner surrounding wall 110, and the second outer contact 220B and the second outer housing 400B are located between the second outer end wall 122 and the inner surrounding wall 110. For example, the first outer contact 220A and the first outer housing 400A are located between the first outer end wall 121 and the first partition wall 111. The first outer housing 400A further includes a first end surface 403 facing away from the first partition wall 111 and the first outer end wall 121 covers the first end surface 403. For example, the second outer contact 220B and the second outer housing 400B are located between the second outer end wall 122 and the second partition wall 112. The second outer housing 400B further includes a second end surface 404 facing away from the second partition wall 112 and the second outer end wall 122 covers the second end surface 404.

The first outer side wall 123 and the second outer side wall 124 each couple the first outer end wall 121 to the second outer end wall 122. Gaps are formed between the first outer side wall 123 and the inner surrounding wall 110 and between the second outer side wall 124 and the inner surrounding wall 110. For example, an inner surface of the first outer side wall 123 (a surface facing the inside of the outer surrounding wall 120) and an outer surface of the first inner side wall 113 (a surface facing the outside of the inner surrounding wall 110) face each other, and a gap is formed between the first outer side wall 123 and the first inner side wall 113. An inner surface of the second outer side wall 124 and an outer surface of the second inner side wall 114 face each other, and a gap is formed between the second outer side wall 124 and the second inner side wall 114.

As illustrated in FIG. 4, the inner surrounding wall 110 includes a first inner end portion 140 close to the circuit board 10 and a second inner end portion 150 away from the circuit board 10. The first inner end portion 140 includes a first inner end portion 141 of the first partition wall 111, a first inner end portion 142 of the second partition wall 112, a first inner end portion 143 of the first inner side wall 113, and a first inner end portion 144 of the second inner side wall 114. The second inner end portion 150 includes a second inner end portion 151 of the first partition wall 111, a second inner end portion 152 of the second partition wall 112, a second inner end portion 153 of the first inner side wall 113, and a second inner end portion 154 of the second inner side wall 114.

Similarly, the outer surrounding wall 120 includes a first outer end portion 160 close to the circuit board 10 and a second outer end portion 170 away from the circuit board 10. The first outer end portion 160 includes a first outer end portion 161 of the first outer end wall 121, a first outer end portion 162 of the second outer end wall 122, a first outer end portion 163 of the first outer side wall 123, and a first outer end portion 164 of the second outer side wall 124. The second outer end portion 170 includes a second outer end portion 171 of the first outer end wall 121, a second outer end portion 172 of the second outer end wall 122, a second outer end portion 173 of the first outer side wall 123, and a second outer end portion 174 of the second outer side wall 124.

The first inner end portion 140 and the first outer end portion 160 are in contact with a conductive pattern (for example, an inner ground pattern 16 and an outer ground pattern 15 described below) of the circuit board 10. The first inner end portion 140 and the first outer end portion 160 are electrically connected to the conductive pattern of the circuit board 10 by soldering or the like.

The first inner end portion 140 is bent toward the inside of the inner surrounding wall 110 over the entire circumference. For example, each of the first inner end portions 141, 142, 143, 144 is bent towards the inside of the inner surrounding wall 110. The first inner end portions 141, 142, 143, 144 are continuous over the entire circumference of the inner surrounding wall 110 to form a first plate 180. The first plate 180 couples the first partition wall 111 to the second partition wall 112 and covers the facing surface 301 of the inner housing 300. The first plate 180 includes an opening 181 that exposes the plurality of inner contacts 210. The first plate 180 is in contact with a conductive pattern (for example, the inner ground pattern 16 described below) of the circuit board 10. The first plate 180 is electrically connected to the conductive pattern of the circuit board 10 by soldering or the like.

The first outer end portion 160 is bent toward the outside of the outer surrounding wall 120 over the entire circumference. For example, each of the first outer end portions 161, 162, 163, 164 is bent toward the outside of the outer surrounding wall 120. The first outer end portions 161, 162, 163, 164 are continuous over the entire circumference of the outer surrounding wall 120 to form a flange.

The shell 100 further includes a coupling plate 130 that couples the second inner end portion 150 of the inner surrounding wall 110 to the second outer end portion 170 of the outer surrounding wall 120, as illustrated in FIGS. 3 and 4. The coupling plate 130 includes a first coupling portion 131, a second coupling portion 132, a third coupling portion 133, and a third coupling portion 134. The first coupling portion 131 couples the second outer end portion 171 of the first outer end wall 121 to the second inner end portion 151 of the first partition wall 111 and covers the opposite surface 402 of the first outer housing 400A. The second coupling portion 132 couples the second outer end portion 172 of the second outer end wall 122 to the second inner end portion 152 of the second partition wall 112 and covers the opposite surface 402 of the second outer housing 400B. The third coupling portion 133 couples the second outer end portion 173 of the first outer side wall 123 to the second inner end portion 153 of the first inner side wall 113. The third coupling portion 134 couples the second outer end portion 174 of the second outer side wall 124 to the second inner end portion 154 of the second inner side wall 114.

An outer curved surface 137 is formed along the entire circumference of the coupling plate 130 at the boundary between the outer surface of the outer surrounding wall 120 and the outer surface of the coupling plate 130 (the opposite surface to the surface facing the circuit board 10) (see FIG. 2). An inner curved surface 138 is formed along the entire circumference of the inner surrounding wall 110 at the boundary between the inner surface of the inner surrounding wall 110 and the outer surface of the coupling plate 130.

In the coupling plate 130, a first opening 135 and a second opening 136 are formed that expose the first outer contact 220A and the second outer contact 220B. For example, the first opening 135 is formed in the first coupling portion 131, and the second opening 136 is formed in the second coupling portion 132 (see FIG. 2).

The shell 100 described above is integrally formed from one sheet material by, for example, drawing. According to the drawing process, the shell 100 may readily be formed such that both of the inner surrounding wall 110 and the outer surrounding wall 120 are seamlessly continuous over the entire circumference, and the inner surrounding wall 110 and the outer surrounding wall 120 are coupled to each other by the coupling plate 130.

### Inner Contact

As illustrated in FIG. 3, the plurality of inner contacts 210 are held in the inner housing 300 in a state of being aligned along one or more rows. Each of the one or more rows extends along a direction in which the first outer housing 400A, the inner housing 300, and the second outer housing 400B are aligned. The one or more rows include, for example, a row L11 and a row L12 that are parallel to each other when viewed from a direction along the axis CL1. The row L11 is located between the row L12 and the first inner side wall 113, and the row L12 is located between the row L11 and the second inner side wall 114. The plurality of inner contacts 210 include inner contacts 210A, 210B, 210C that are arranged along the row L11 and inner contacts 210D, 210E, 210F that are arranged along the row L12.

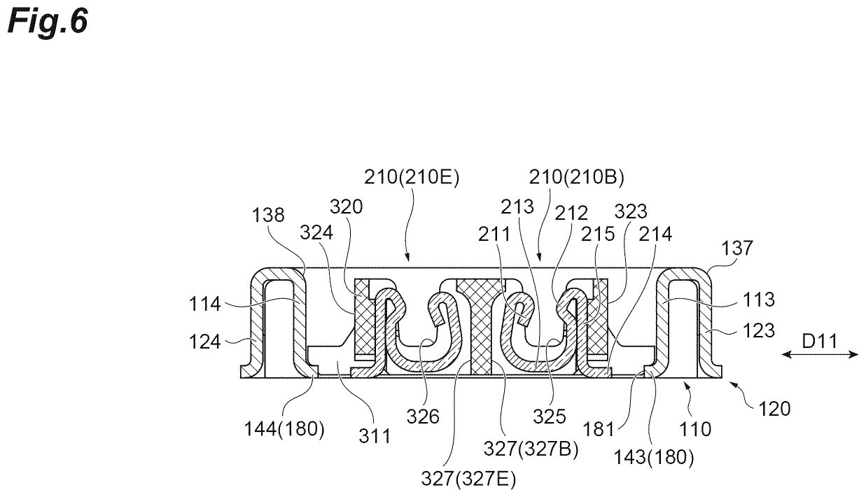

In FIG. 6, a cross section of the inner contacts 210B, 210E is illustrated. As illustrated in FIG. 6, the inner contact 210 is formed to contact the inner contact 610 from two directions along a direction perpendicular to the first outer side wall 123 and the second outer side wall 124 (a contact direction D11 parallel to the circuit board 10 and the first outer end wall 121). For example, the inner contact 210 includes a first contact portion 211, a second contact portion 212, a first coupling portion 213, a connecting portion 214, and a second coupling portion 215. The first contact portion 211 contacts the inner contact 610 from one side in the contact direction D11, and the second contact portion 212 contacts the inner contact 610 from the other side in the contact direction D11. The contact surface of the first contact portion 211 against the inner contact 610 and the contact surface of the second contact portion 212 against the inner contact 610 face each other along the contact direction D11. The first coupling portion 213 is elastic and couples the first contact portion 211 to the second contact portion 212. For example, the first coupling portion 213 extends from the first contact portion 211 toward the circuit board 10, is folded back in a U-shape, and is connected to the second contact portion 212.

The second coupling portion 215 couples the second contact portion 212 to the connecting portion 214. For example, the second coupling portion 215 extends from the second contact portion 212 toward the circuit board 10 and is connected to the connecting portion 214. The connecting portion 214 is bent with respect to the second coupling portion 215 and extends along the circuit board 10 in a direction away from the first coupling portion 213. The connecting portion 214 is in contact with a conductive pattern (the inner signal pattern 12 described below) of the circuit board 10. The connecting portion 214 is electrically connected to the conductive pattern of the circuit board 10 by soldering or the like.

In each of the plurality of inner contact 210, the first contact portion 211 is arranged inside the inner surrounding wall 110 with respect to the second contact portion 212. The connecting portion 214 of the inner contacts 210A, 210B, 210C extends in the inner surrounding wall 110 toward the inner surface of the first inner side wall 113 and faces the first inner end portion 143 of the first inner side wall 113 (the inner edge of the opening 181). The connecting portion 214 of the inner contacts 210D, 210E, 210F extends in the inner surrounding wall 110 toward the inner surface of the second inner side wall 114 and faces the first inner end portion 144 of the second inner side wall 114 (the inner edge of the opening 181).

Each of the plurality of inner contacts 210 is formed by, for example, punching and bending a thin metallic plate material.

### Outer Contact

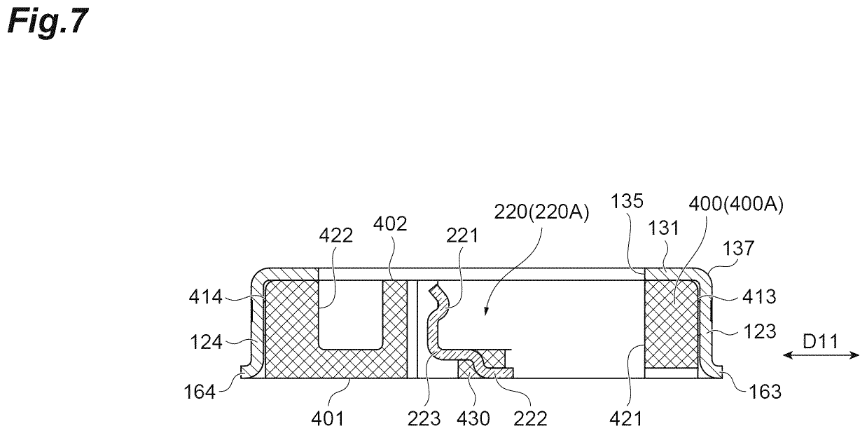

In FIG. 7, a cross section of the first outer contact 220A is illustrated. The first outer contact 220A is formed along the contact direction D11 so as to contact the outer contact 620 from one direction. For example, the first outer contact 220A includes a contact portion 221, a connecting portion 222, and a coupling portion 223.

The contact portion 221 contacts the outer contact 620 from one side of the contact direction D11. The connecting portion 222 is in contact with a conductive pattern (the first outer signal pattern 13 described below) of the circuit board 10. The connecting portion 222 is electrically connected to the conductive pattern of the circuit board 10 by soldering or the like. The coupling portion 223 is elastic and couples the contact portion 221 to the connecting portion 222. For example, the coupling portion 223 extends from the contact portion 221 toward the circuit board 10 and is connected to the connecting portion 222. The connecting portion 222 is bent with respect to the coupling portion 223 and extends along the circuit board 10 in a direction in which the contact surface of the contact portion 221 with respect to the outer contact 620 faces.

The second outer contact 220B is substantially the same member as the first outer contact 220A. Each of the first outer contact 220A and the second outer contact 220B is formed by punching and bending a metallic thin sheet material.

### Inner Housing

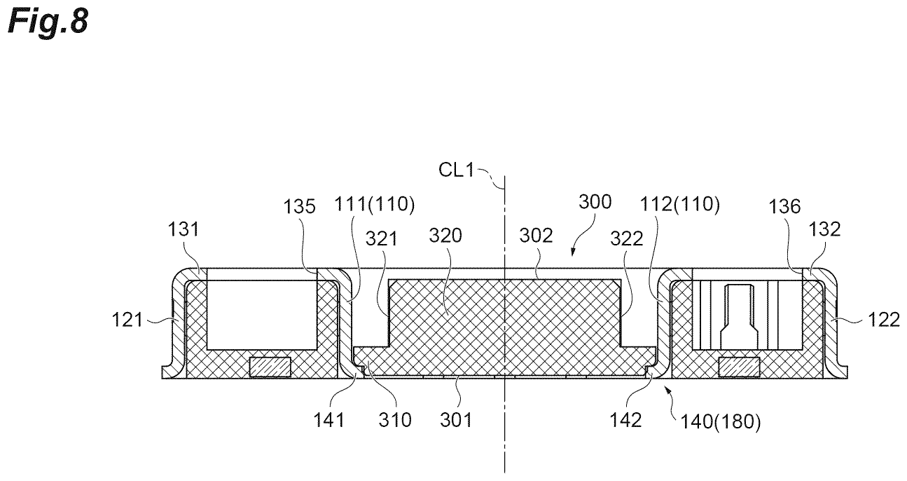

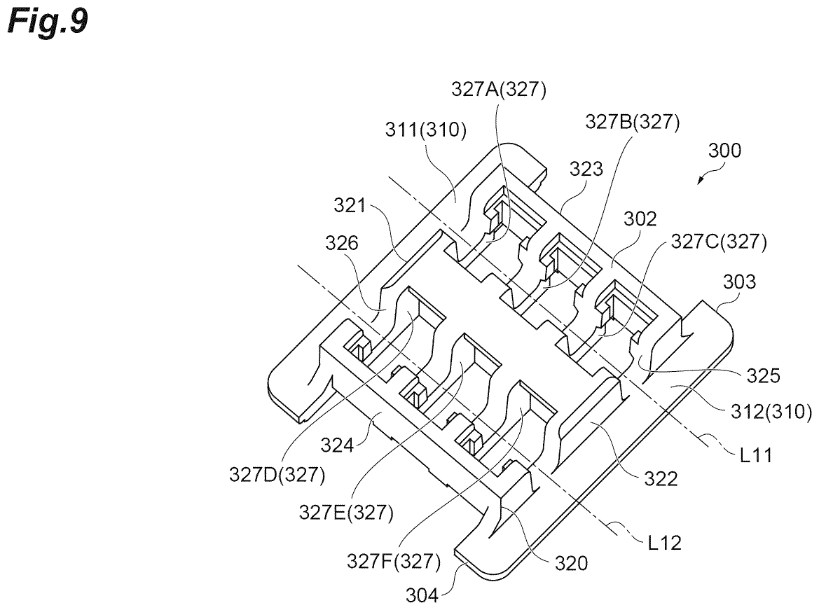

FIG. 9 is a perspective view of the inner housing 300. As illustrated in FIG. 8, the inner housing 300 arranged in the inner surrounding wall 110 is in contact with the first inner end portion 140 in the direction along the axis CL1. For example, the inner housing 300 is in contact with the first inner end portion 141, the first inner end portion 142, the first inner end portion 143, and the first inner end portion 144 in the inner surrounding wall 110.

For example, the inner housing 300 includes a base portion 310 and a contact holding portion 320. The base portion 310 is in contact with the first inner end portion 140 (the first plate 180) in the direction along the axis CL1. The base portion 310 includes the facing surface 301 mentioned above and the facing surface 301 is in contact with the first inner end portion 140. The outer peripheral surface of the base portion 310 is in contact with the inner surface of the inner surrounding wall 110. The contact holding portion 320 protrudes from the base portion 310 in a direction away from the circuit board 10 and holds the plurality of inner contacts 210.

As illustrated in FIG. 9, the contact holding portion 320 has a substantially rectangular shape when viewed from the direction along the axis CL1, and includes a first side 321 and a second side 322 that are parallel to each other and a third side 323 and a fourth side 324 that are parallel to each other. The first side 321 faces the first partition wall 111, the second side 322 faces the second partition wall 112, the third side 323 faces the first inner side wall 113, and the fourth side 324 faces the second inner side wall 114. A gap is formed between the contact holding portion 320 and the inner surrounding wall 110 over the entire circumference (see FIG. 5). For example, a gap is formed between the first side 321 and the first partition wall 111, a gap is formed between the second side 322 and the second partition wall 112, a gap is formed between the third side 323 and the first inner side wall 113, and a gap is formed between the fourth side 324 and the second inner side wall 114.

The contact holding portion 320 includes the opposite surface 302 as described above. In the contact holding portion 320, a first groove portion 325 along the row L11 and a second groove portion 326 along the row L12 are formed. Both the first groove portion 325 and the second groove portion 326 open in the opposite surface 302. The contact holding portion 320 further includes a plurality of contact accommodating holes 327 each accommodating the plurality of inner contacts 210.

For example, the plurality of contact accommodating holes 327 includes contact accommodating holes 327A, 327B, 327C and contact accommodating holes 327D, 327E, 327F. The contact accommodating holes 327A, 327B, 327C are arranged along the row L11, and accommodate the inner contacts 210A, 210B, 210C, respectively. For example, the contact accommodating holes 327A, 327B, 327C have an opening on the inner surface of the first groove portion 325, and expose the first contact portion 211 and the second contact portion 212 of the inner contacts 210A, 210B, 210C in the first groove portion 325. The contact accommodating holes 327D, 327E, 327F are arranged along the row L12, and accommodate the inner contacts 210D, 210E, 210F, respectively. For example, the contact accommodating holes 327D, 327E, 327F have an opening on the inner surface of the second groove portion 326, and the first contact portion 211 and expose the second contact portion 212 of the inner contacts 210D, 210E, 210F in the second groove portion 326.

The base portion 310 includes a first base portion 311 and a second base portion 312. The first base portion 311 protrudes from the first side 321 toward the first partition wall 111 and is in contact with the inner surface of the first partition wall 111 and the inner surface of the first inner end portion 141. The second base portion 312 protrudes from the second side 322 toward the second partition wall 112 and is in contact with the inner surface of the second partition wall 112 and the inner surface of the first inner end portion 142.

One end of the first base portion 311 and the second base portion 312 protrudes from the third side 323 toward the first inner side wall 113 and is in contact with the inner surface of the first inner side wall 113 and the inner surface of the first inner end portion 143. The first side 303 of the inner housing 300 mentioned above is formed by the end surface of the first base portion 311 and the end surface of the second base portion 312 that are in contact with the inner surface of the first inner side wall 113. One end of the first base portion 311 and one end of the second base portion 312 form a region that exposes the connecting portion 214 of the inner contacts 210A, 210B, 210C between the end surface of the first inner end portion 143 and the third side 323.

The other ends of the first base portion 311 and the second base portion 312 protrude from the third side 323 toward the second inner side wall 114 and are in contact with the inner surface of the second inner side wall 114 and the inner surface of the first inner end portion 144. The second side 304 of the inner housing 300 mentioned above is formed by the end surface of the first base portion 311 and the end surface of the second base portion 312 which are in contact with the inner surface of the second inner side wall 114. The other end of the first base portion 311 and the other end of the second base portion 312 form a region that exposes the connecting portion 214 of the inner contacts 210D, 210E, 210F between the end surface of the first inner end portion 144 and the fourth side 324 (see FIG. 5).

The inner housing 300 is formed by, for example, injection molding of a resin material.

### Outer Housing

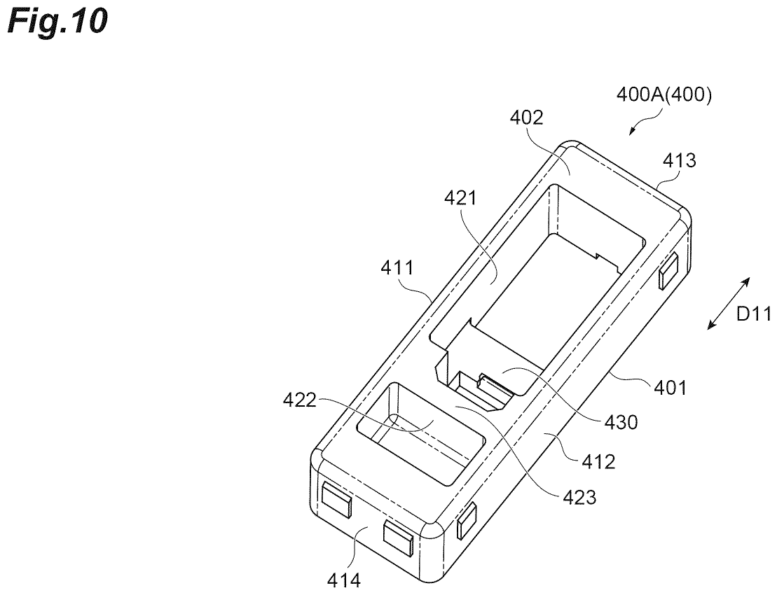

FIG. 10 is a perspective view of the first outer housing 400A. As illustrated in FIG. 10, the first outer housing 400A has a rectangular shape when viewed from the direction along the axis CL1, and includes a first side 411 and a second side 412 that are parallel to each other, and a third side 413 and a fourth side 414 that are parallel to each other. The first side 411 and the second side 412 lie along the contact direction D11 described above.

Further, the first outer housing 400A includes an accommodation hole 421, a fitting hole 422, and a contact holding portion 430. The accommodation hole 421 and the fitting hole 422 are aligned along the contact direction D11. The accommodation hole 421 penetrates between the facing surface 401 and the opposite surface 402. The fitting hole 422 is open to the opposite surface 402. The accommodation hole 421 and the fitting hole 422 are separated by a partition 423. The accommodation hole 421 is located between the fitting hole 422 and the third side 413, and the fitting hole 422 is located between the accommodation hole 421 and the fourth side 414. The accommodation hole 421 accommodates the first outer contact 220A. The contact holding portion 430 holds the first outer contact 220A within the accommodation hole 421. For example, the contact holding portion 430 holds the first outer contact 220A so that the contact surface of the contact portion 221 with respect to a contact portion 621 faces away from the partition 423. Accordingly, the connecting portion 222 bent with respect to the coupling portion 223 extends in a direction away from the partition 423.

The second outer housing 400B is substantially the same member as the first outer housing 400A. In the second outer housing 400B, the second outer contact 220B is held in the accommodation hole 421 by the contact holding portion 430. The relative placement of the second outer contact 220B with respect to the second outer housing 400B is the same as the relative placement of the first outer contact 220A with respect to the first outer housing 400A. Accordingly, a unit combining the second outer housing 400B and the second outer contact 220B is substantially the same unit as a unit combining the first outer housing 400A and the first outer contact 220A.

The first outer housing 400A and the second outer housing 400B are arranged so as to be point-symmetrical to each other when viewed from the direction along the axis CL1. Accordingly, the first outer contact 220A and the second outer contact 220B are point-symmetrical to each other when viewed from the direction along the axis CL1. The above-mentioned first end surface 403 covered by the first outer end wall 121 (see FIG. 5) is formed by the first side 411 of the first outer housing 400A. The above-mentioned second end surface 404 covered by the second outer end wall 122 (see FIG. 5) is formed by the first side 411 of the second outer housing 400B.

### Conductive Pattern of Circuit Board

FIG. 11 is a schematic diagram illustrating the conductive pattern of the circuit board 10. As illustrated in FIG. 11, a ground pattern 11, a plurality of inner signal patterns 12, the first outer signal pattern 13, and the second outer signal pattern 14 are formed on the mounting surface of the circuit board 10. The ground pattern 11 includes the outer ground pattern 15 and the inner ground pattern 16. The outer ground pattern 15 has a rectangular shape corresponding to the first outer end portion 160 of the outer surrounding wall 120. The first outer end portion 160 is in contact with the outer ground pattern 15 over the entire circumference and is electrically connected to the outer ground pattern 15 by soldering or the like. The inner ground pattern 16 includes a first partition pattern 17 and a second partition pattern 18 that divide the interior of the outer ground pattern 15. The first partition pattern 17 corresponds to the first inner end portion 141 of the first partition wall 111 and the second partition pattern 18 corresponds to the first inner end portion 142 of the second partition wall 112. The first inner end portion 141 is in contact with the first partition pattern 17 and is electrically connected to the first partition pattern 17 by soldering or the like. The first inner end portion 142 is in contact with the second partition pattern 18 and is electrically connected to the second partition pattern 18 by soldering or the like.

The plurality of inner signal patterns 12 are arranged between the first partition pattern 17 and the second partition pattern 18 in the outer ground pattern 15. The plurality of inner signal patterns 12 respectively correspond to the plurality of inner contacts 210. The connecting portions 214 of the plurality of inner contacts 210 are in contact with the plurality of inner signal patterns 12, respectively, and are electrically connected to the plurality of inner signal patterns 12, respectively, by soldering or the like. For example, the plurality of inner signal patterns 12 include inner signal patterns 12A, 12B, 12C corresponding to the inner contacts 210A, 210B, 210C and inner signal patterns 12D, 12E, 12F corresponding to the inner contacts 210D, 210E, 210F.

The first outer signal pattern 13 corresponds to the first outer contact 220A. The connecting portion 222 of the first outer contact 220A is in contact with the first outer signal pattern 13 and is electrically connected to the first outer signal pattern 13 by soldering or the like. The second outer signal pattern 14 corresponds to the second outer contact 220B. The connecting portion 222 of the second outer contact 220B is in contact with the second outer signal pattern 14 and is electrically connected to the second outer signal pattern 14 by soldering or the like.

In the circuit board 10, the first outer signal pattern 13 and the second outer signal pattern 14 are used to transmit high-frequency signals (for example, RF signals) as compared to signals transmitted by each of the plurality of inner signal patterns 12.

### Plug Connector

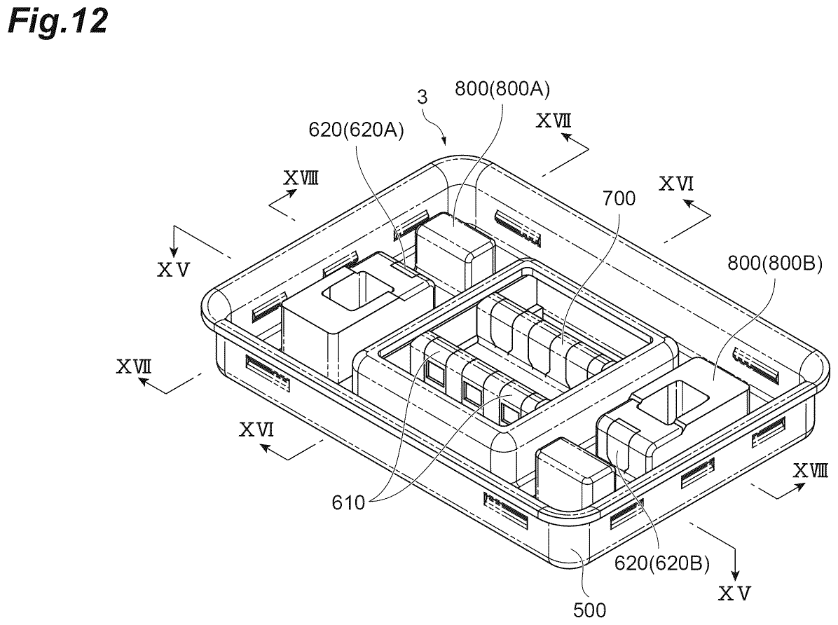

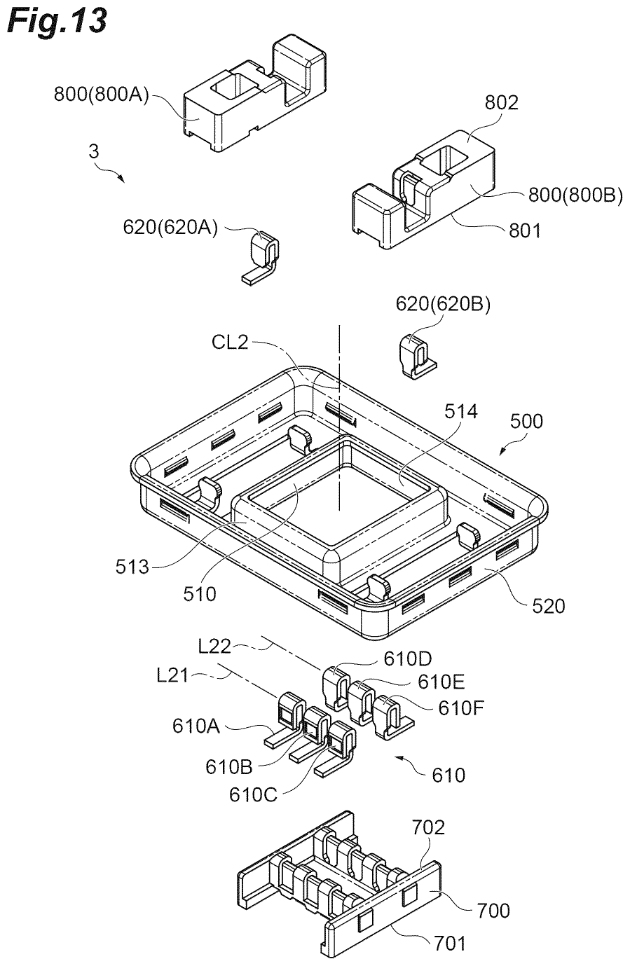

FIG. 12 is a perspective view illustrating the configuration of the plug connector 3. FIG. 13 is an exploded perspective view of the plug connector 3. As illustrated in FIGS. 12 and 13, the plug connector 3 includes a shell 500, a plurality of inner contacts 610, the one or more outer contacts 620, an inner housing 700, and an outer housing 800.

The shell 500 includes an inner surrounding wall 510 and an outer surrounding wall 520. The shell 500 is formed of a metallic sheet material or the like, and has conductivity. The inner surrounding wall 510 surrounds the axis CL2. The outer surrounding wall 520 surrounds the axis CL2 and the inner surrounding wall 510.

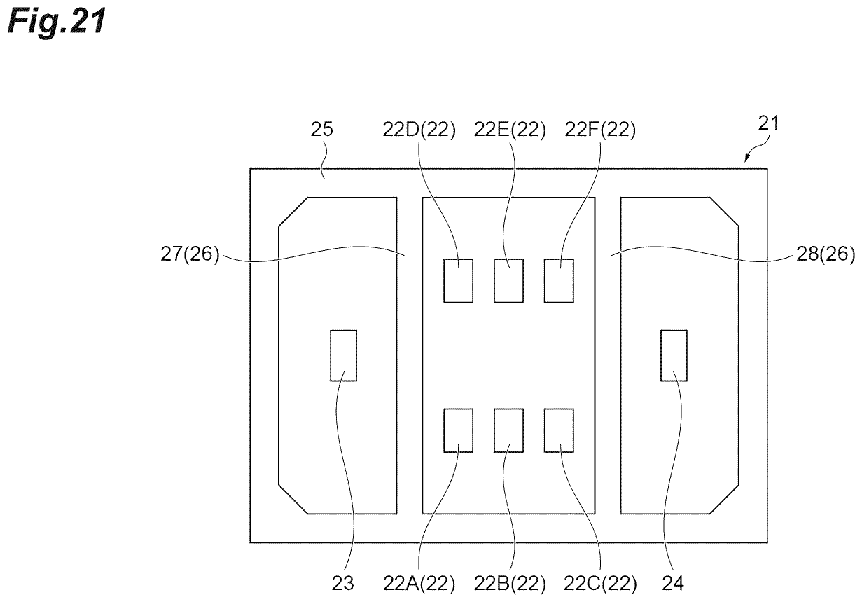

The plurality of inner contacts 610 are disposed within the inner surrounding wall 510 and are electrically connected to the circuit board 20. Each of the plurality of inner contacts 610 is formed of a metallic sheet material or the like, and has conductivity. For example, the plurality of inner contacts 610 are electrically connected to a plurality of conductive patterns (for example, a plurality of inner signal patterns 22 described below) formed on the surface of the circuit board 20, respectively (see FIG. 21). When the plug connector 3 is connected to the receptacle connector 2, the plurality of inner contacts 610 are in contact with the plurality of inner contacts 210 of the receptacle connector 2.

The one or more outer contacts 620 are disposed between the inner surrounding wall 510 and the outer surrounding wall 520 and are electrically connected to the circuit board 20. Each of the one or more outer contacts 620 is formed of a metallic sheet material or the like, and has conductivity. For example, the one or more outer contacts 620 are electrically connected to one or more conductive patterns (for example, a first outer signal pattern 23 and a second outer signal pattern 24, which will be described below) formed on the circuit board 20 (see FIG. 21). When the plug connector 3 is connected to the receptacle connector 2, the one or more outer contacts 620 are in contact with the one or more outer contacts 220 of the receptacle connector 2, respectively.

In one example, the one or more outer contacts 620 include the first outer contact 620A and the second outer contact 620B, and the inner surrounding wall 510 is located between the first outer contact 620A and the second outer contact 620B. The first outer contact 620A is electrically connected to the first outer signal pattern 23 described below, and the second outer contact 620B is electrically connected to the second outer signal pattern 24 described below. When the plug connector 3 is connected to the receptacle connector 2, the first outer contact 620A is in contact with the first outer contact 220A of the receptacle connector 2 and the second outer contact 620B is in contact with the second outer contact 220B of the receptacle connector 2.

The inner housing 700 holds a plurality of inner contacts 610 within the inner surrounding wall 510. The inner housing 700 is formed of a resin material or the like and has an insulating property. By the inner housing 700, the plurality of inner contacts 610 are insulated from each other, and each of the plurality of inner contacts 610 and the inner surrounding wall 510 are insulated from each other. The inner housing 700 includes a facing surface 701 facing the circuit board 20 and an opposite surface 702 on the opposite side of the facing surface 701.

The outer housing 800 holds the one or more outer contacts 620 between the outer surrounding wall 520 and the inner surrounding wall 510. The outer housing 800 is formed of a resin material or the like and has an insulating property. The outer housing 800 isolates the one or more outer contacts 620 (for example, the first outer contact 620A and the second outer contact 620B) from each other, isolates each of the one or more outer contacts 620 from the inner surrounding wall 510, and isolates each of the one or more outer contacts 620 from the outer surrounding wall 520.

The outer housing 800 is formed separately from the inner housing 700. For example, the inner housing 700 and the outer housing 800 are fixed to the shell 500 in a state of being divided by the inner surrounding wall 510. Without the shell 500, the inner housing 700 and the outer housing 800 are not secured to each other.

The outer housing 800 may include a first outer housing 800A and a second outer housing 800B. The first outer housing 800A is formed separately from the inner housing 700 and holds the first outer contact 620A. The first outer housing 800A includes a facing surface 801 facing the circuit board 20 and an opposite surface 802 on the opposite side of the facing surface 801.

The second outer housing 800B is formed separately from both the inner housing 700 and the first outer housing 800A and holds the second outer contact 620B. When viewed from a direction along the axis CL2, the inner housing 700 is located between the first outer housing 800A and the second outer housing 800B. For example, the first outer housing 800A and the inner housing 700 are divided by the inner surrounding wall 510, and the second outer housing 800B and the inner housing 700 are divided by the inner surrounding wall 510. Accordingly, the first outer housing 800A and the second outer housing 800B are divided by the inner surrounding wall 510. Similarly to the first outer housing 800A, the second outer housing 800B includes the facing surface 801 facing the circuit board 20 and the opposite surface 802 on the opposite side of the facing surface 801.

Hereinafter, configurations of the shell 500, the inner contact 610, the first outer contact 620A, the second outer contact 620B, the inner housing 700, the first outer housing 800A, and the second outer housing 800B will be described in more detail with reference to other drawings.

### Shell

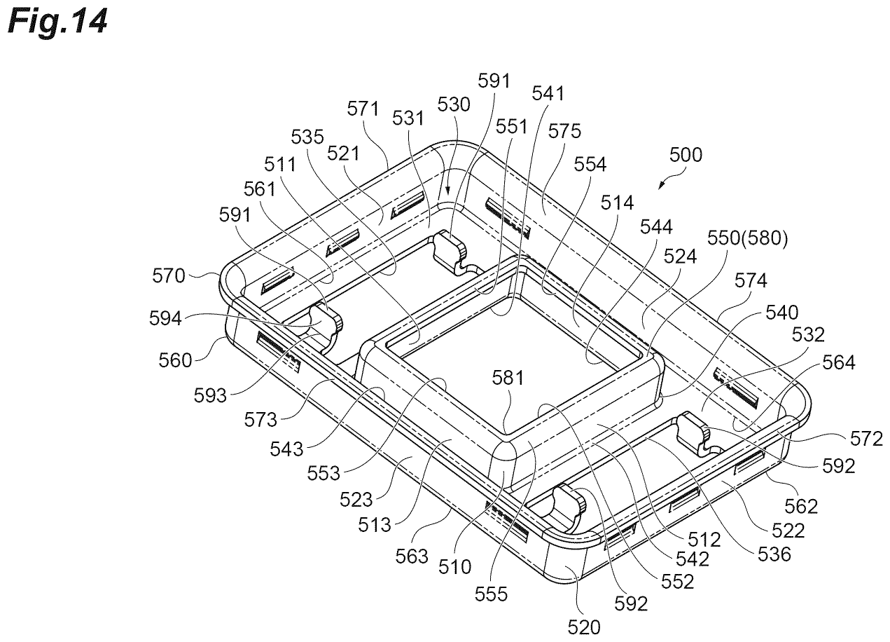

FIG. 14 is a perspective view of the shell 500 illustrated in FIG. 13 seen from the opposite direction. As illustrated in FIG. 14, each of the inner surrounding wall 510 and the outer surrounding wall 520 may be seamlessly continuous over the entire circumference.

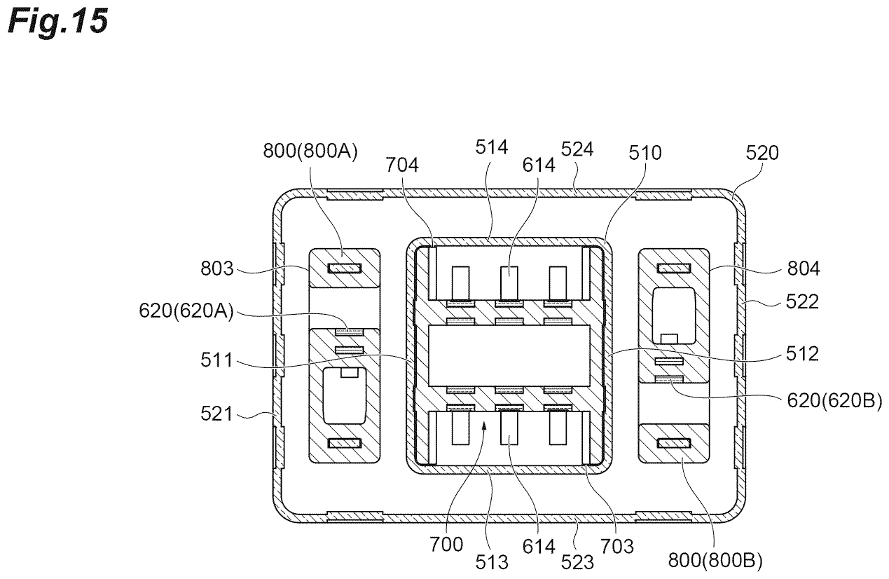

As illustrated in FIG. 15, the inner surrounding wall 510 has a rectangular shape when viewed from the direction along the axis CL2, and includes a first partition wall 511 and a second partition wall 512 that are parallel to each other and a first inner side wall 513 and a second inner side wall 514 that are parallel to each other. The first partition wall 511 is located between the inner housing 700 and the first outer housing 800A, and the second partition wall 512 is located between the inner housing 700 and the second outer housing 800B. Each of the first inner side wall 513 and the second inner side wall 514 couples the first partition wall 511 to the second partition wall 512.

The inner housing 700 includes a first side 703 facing the first inner side wall 513 and a second side 704 facing the second inner side wall 514, as illustrated in FIG. 15. The first side 703 and the second side 704 are parallel to each other, and each of the first side 703 and the second side 704 lies along a plane that intersects (for example, is orthogonal to) both the circuit board 20 and the first partition wall 511. Each of the first partition wall 511 and the second partition wall 512 extends from the first side 703 to the second side 704 to couple the first inner side wall 513 to the second inner side wall 514.

As illustrated in FIG. 15, the outer surrounding wall 520 has a rectangular shape when viewed from the direction along the axis CL2, and includes a first outer end wall 521 and a second outer end wall 522 that are parallel to each other and a first outer side wall 523 and a second outer side wall 524 that are parallel to each other. The first outer contact 620A and the first outer housing 800A are placed between the first outer end wall 521 and the inner surrounding wall 510, and the second outer contact 620B and the second outer housing 800B are placed between the second outer end wall 522 and the inner surrounding wall 510. For example, the first outer contact 620A and the first outer housing 800A are located between the first outer end wall 521 and the first partition wall 511. The first outer housing 800A further includes a first end surface 803 facing away from the first partition wall 511 and the first outer end wall 521 covers the first end surface 803. For example, the second outer contact 620B and the second outer housing 800B are located between the second outer end wall 522 and the second partition wall 512. The second outer housing 800B further includes a second end surface 804 facing away from the second partition wall 512 and the second outer end wall 522 covers the second end surface 804.

Each of the first outer side wall 523 and the second outer side wall 524 couples the first outer end wall 521 to the second outer end wall 522. Gaps are formed between the first outer side wall 523 and the inner surrounding wall 510 and between the second outer side wall 524 and the inner surrounding wall 510. For example, an inner surface of the first outer side wall 523 (a surface facing the inside of the outer surrounding wall 520) and an outer surface of the first inner side wall 513 (a surface facing the outside of the inner surrounding wall 510) face each other, and a gap is formed between the first outer side wall 523 and the first inner side wall 513. An inner surface of the second outer side wall 524 (a surface facing the inside of the outer surrounding wall 520) and an outer surface of the second inner side wall 514 (a surface facing the outside of the inner surrounding wall 510) face each other, and a gap is formed between the second outer side wall 524 and the second inner side wall 514.

As illustrated in FIG. 14, the inner surrounding wall 510 includes a first inner end portion 540 close to the circuit board 20 and a second inner end portion 550 away from the circuit board 20. The first inner end portion 540 includes a first inner end portion 541 of the first partition wall 511, a first inner end portion 542 of the second partition wall 512, a first inner end portion 543 of the first inner side wall 513, and a first inner end portion 544 of the second inner side wall 514. The second inner end portion 550 includes a second inner end portion 551 of the first partition wall 511, a second inner end portion 552 of the second partition wall 512, a second inner end portion 553 of the first inner side wall 513, and a second inner end portion 554 of the second inner side wall 514.

Similarly, the outer surrounding wall 520 includes a first outer end portion 560 close to the circuit board 20 and a second outer end portion 570 away from the circuit board 20. The first outer end portion 560 includes a first outer end portion 561 of the first outer end wall 521, a first outer end portion 562 of the second outer end wall 522, a first outer end portion 563 of the first outer side wall 523, and a first outer end portion 564 of the second outer side wall 524. The second outer end portion 570 includes a second outer end portion 571 of the first outer end wall 521, a second outer end portion 572 of the second outer end wall 522, a second outer end portion 573 of the first outer side wall 523, and a second outer end portion 574 of the second outer side wall 524.

As illustrated in FIG. 14, the second inner end portion 550 is bent toward the inside of the inner surrounding wall 510 over the entire circumference. For example, each of the second inner end portions 551, 552, 553, 554 is bent toward the inside of the inner surrounding wall 510. The second inner end portions 551, 552, 553, 554 are continuous over the entire circumference of the inner surrounding wall 510 to form a first plate 580. The first plate 580 couples the first partition wall 511 to the second partition wall 512 and covers the opposite surface 702 on the opposite side of the inner housing 700. The first plate 580 includes an opening 581 that exposes the plurality of inner contacts 610. An inner curved surface 555 is formed along the entire circumference of the inner surrounding wall 510 at the boundary between the outer surface of the inner surrounding wall 510 and the outer surface of the first plate 580.

The second outer end portion 570 is bent toward the outside of the outer surrounding wall 520 over the entire circumference. For example, each of the second outer end portions 571, 572, 573, 574 is bent toward the outside of the outer surrounding wall 520. The second outer end portions 571, 572, 573, 574 are continuous over the entire circumference of the outer surrounding wall 520 to form a flange. Hereinafter, of both surfaces of the flange formed by the second outer end portions 571, 572, 573, 574, a surface continuous with the inner surface of the outer surrounding wall 520 is referred to as a first surface of the second outer end portion 570. An outer curved surface 575 is formed along the entire circumference of the outer surrounding wall 520 at the boundary between the inner surface of the outer surrounding wall 520 and the first surface of the second outer end portion 570.

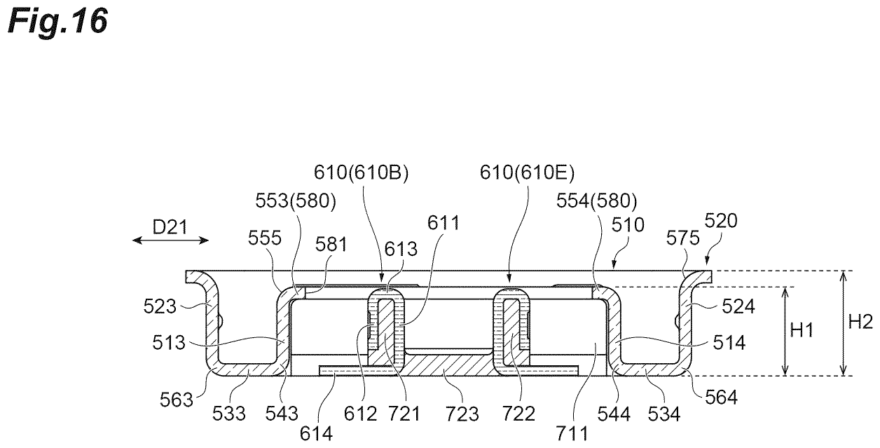

The shell 500 further includes a coupling plate 530 that couples the first inner end portion 540 of the inner surrounding wall 510 to the first outer end portion 560 of the outer surrounding wall 520. The coupling plate 530 includes a first coupling portion 531, a second coupling portion 532, a third coupling portion 533, and a fourth coupling portion 534. The first coupling portion 531 couples the first outer end portion 561 of the first outer end wall 521 to the first inner end portion 541 of the first partition wall 511 and covers the facing surface 801 of the first outer housing 800A. The second coupling portion 532 couples the first outer end portion 562 of the second outer end wall 522 to the first inner end portion 542 of the second partition wall 512 and covers the facing surface 801 of the second outer housing 800B. As illustrated in FIG. 16, the third coupling portion 533 couples the first outer end portion 563 of the first outer side wall 523 to the first inner end portion 543 of the first inner side wall 513. The fourth coupling portion 534 couples the first outer end portion 564 of the second outer side wall 524 to the second inner end portion 554 of the second inner side wall 514.

In the coupling plate 530, a first opening 535 and a second opening 536 are formed that expose the first outer contact 620A and the second outer contact 620B. For example, the first opening 535 is formed in the first coupling portion 531, and the second opening 536 is formed in the second coupling portion 532. The coupling plate 530 is in contact with a conductive pattern of the circuit board 20 (for example, an inner ground pattern 26 and an outer ground pattern 25 described below). For example, the first coupling portion 531 is in contact with the outer ground pattern 25 and a first partition pattern 27 described below, the second coupling portion 532 is in contact with the outer ground pattern 25 and a second partition pattern 28 described below, and the third coupling portion 533 and the fourth coupling portion 534 are in contact with the outer ground pattern 25. The coupling plate 530 is electrically connected to the conductive pattern of the circuit board 20 by soldering or the like.

As illustrated in FIG. 14, one or more first anchors 591 to be inserted into the first outer housing 800A and one or more second anchors 592 to be inserted into the second outer housing 800B are formed in the coupling plate 530. For example, the first coupling portion 531 is formed with a pair of first anchors 591 to be inserted into the first outer housing 800A. The pair of first anchors 591 are respectively formed at two positions facing each other along a direction parallel to the first partition wall 511 in the inner periphery of the first opening 535. Each of the pair of first anchors 591 includes a protrusion 593 and an end portion 594. The protrusion 593 protrudes from the inner surface of the first coupling portion 531 into the space surrounded by the outer surrounding wall 520. The end portion 594 further protrudes from the end portion of the first coupling portion 531. The width of the end portion 594 is larger than the width of the protrusion 593. The end portion 594 acts as a retainer for the first anchor 591 from the first outer housing 800A.

The second coupling portion 532 is formed with a pair of second anchors 592 to be inserted into the second outer housing 800B. The pair of second anchors 592 are respectively formed at two positions facing each other along a direction parallel to the second partition wall 512 in the inner periphery of the second opening 536. Each of the pair of second anchors 592 includes the protrusion 593 and the end portion 594, similarly to the first anchor 591. The protrusion 593 protrudes from the inner surface of the second coupling portion 532 into the space surrounded by the outer surrounding wall 520. The end portion 594 further protrudes from the end of the protrusion 593. The width of the end portion 594 is larger than the width of the protrusion 593. The end portion 594 acts as a retainer for the second anchor 592 from the second outer housing 800B.

The shell 100 described above is integrally formed from one plate material by, for example, drawing. By the drawing process, the shell 100 may readily be formed such that both of the inner surrounding wall 110 and the outer surrounding wall 120 are seamlessly continuous over the entire circumference, and the inner surrounding wall 110 and the outer surrounding wall 120 are coupled to each other by the coupling plate 130.

As illustrated in FIG. 16, the height H1 of the inner surrounding wall 510 with respect to the coupling plate 530 may be lower than the height H2 of the outer surrounding wall 520 with respect to the coupling plate 530.

### Inner Contact

As illustrated in FIG. 13, the plurality of inner contacts 610 are held by the inner housing 700 in a state of being arranged along one or more rows. Each of the one or more rows extends along a direction in which the first outer housing 800A, the inner housing 700, and the second outer housing 800B are arranged. The one or more rows include, for example, a row L21 and a row L22 that are parallel to each other when viewed from a direction along the axis CL2. The row L21 is located between the row L22 and the first inner side wall 513, and the row L22 is located between the row L21 and the second inner side wall 514. The plurality of inner contacts 610 include inner contacts 610A, 610B, 610C that are arranged along the row L21 and inner contacts 610D, 610E, 610F that are arranged along the row L22.

In FIG. 16, a cross section of inner contacts 610B, 610E is illustrated. As illustrated in FIG. 16, the inner contact 610 is formed to contact the inner contact 210 from two directions along a contact direction D21 perpendicular to the first outer side wall 523 and the second outer side wall 524 (parallel to the circuit board 20 and the first outer end wall 521). For example, the inner contact 610 has a first contact portion 611, a second contact portion 612, a first coupling portion 613, and a connecting portion 614. The first contact portion 611 contacts the inner contact 210 from one side in the contact direction D21, and the second contact portion 612 contacts the inner contact 210 from the other side in the contact direction D21. The contact surface of the first contact portion 611 against the inner contact 210 and the contact surface of the second contact portion 612 against the inner contact 210 are opposite to each other along the contact direction D21. The first coupling portion 613 couples the second contact portion 612 to the first contact portion 611. For example, the first coupling portion 613 extends from the second contact portion 612 in a direction away from the circuit board 20, is folded back in a U-shape, and is connected to the first contact portion 611.

The first contact portion 611 extends from the first coupling portion 613 toward the circuit board 20 and is coupled to the connecting portion 614. The connecting portion 614 is bent with respect to the first contact portion 611 and extends along the circuit board 20 toward a direction in which the second contact portion 612 is arranged with respect to the first contact portion 611 (a direction in which the contact surface of the second contact portion 612 faces). The connecting portion 614 is in contact with a conductive pattern (the inner signal pattern 22 described below) of the circuit board 20. The connecting portion 614 is electrically connected to the conductive pattern of the circuit board 20 by soldering or the like.

Each of the plurality of inner contacts 610 is arranged so that the first contact portion 611 is located more inward in the inner surrounding wall 510 than the second contact portion 612. The connecting portion 614 of the inner contacts 610A, 610B, 610C extends in the inner surrounding wall 510 towards the inner surface of the first inner side wall 513 and faces the first inner end portion 543 of the first inner side wall 513. The connecting portion 614 of the inner contacts 610D, 610E, 610F extends in the inner surrounding wall 510 towards the inner surface of the second inner side wall 514 and faces the first inner end portion 544 of the second inner side wall 514.

Each of the plurality of inner contacts 610 is formed by, for example, punching and bending a thin metallic plate material.

### Outer Contact

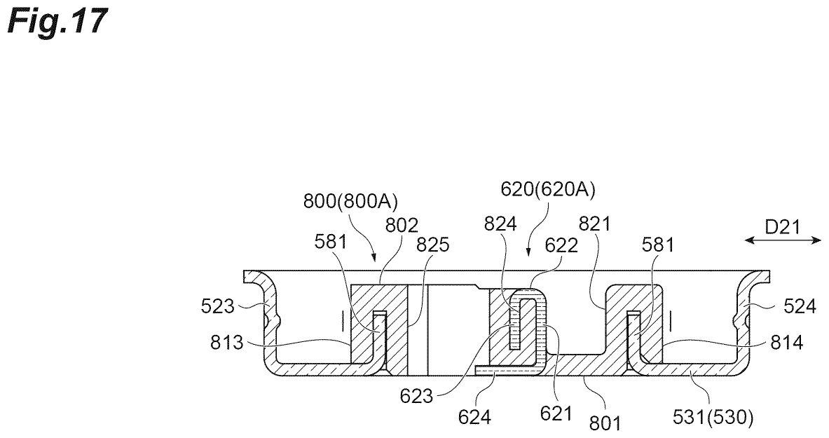

In FIG. 17, a cross section of the first outer contact 620A is illustrated. The first outer contact 620A is formed along the above-described contact direction D21 so as to contact the outer contact 220 from one direction. For example, the first outer contact 620A includes the contact portion 621, a coupling portion 622, an insertion portion 623, and a connecting portion 624.

The contact portion 621 contacts the outer contact 220 from one side of the contact direction D21. The coupling portion 622 couples the contact portion 621 to the insertion portion 623. For example, the coupling portion 622 extends from the contact portion 621 in a direction away from the circuit board 10, is folded back in a U-shape, and is connected to the insertion portion 623. The insertion portion 623 extends from the coupling portion 622 toward the circuit board 10 and is inserted into the first outer housing 800A. The contact portion 621 extends from the insertion portion 623 towards the circuit board 10 and is connected to the connecting portion 624. The contact surface of the contact portion 621 against the outer contact 220 faces in a direction opposite to the direction in which the insertion portion 623 is placed with respect to the contact portion 621.

The connecting portion 624 is bent with respect to the contact portion 621 and extends along the circuit board 20 toward a direction in which the insertion portion 623 is arranged with respect to the contact portion 621 (a direction opposite to a direction in which the contact surface of the contact portion 621 faces). The connecting portion 624 is in contact with a conductive pattern (the first outer signal pattern 23 described below) of the circuit board 20. The connecting portion 624 is electrically connected to the conductive pattern of the circuit board 20 by soldering or the like.

The second outer contact 620B is substantially the same member as the first outer contact 620A. Each of the first outer contact 620A and the second outer contact 620B is formed by punching and bending a metallic thin sheet material.

### Inner Housing

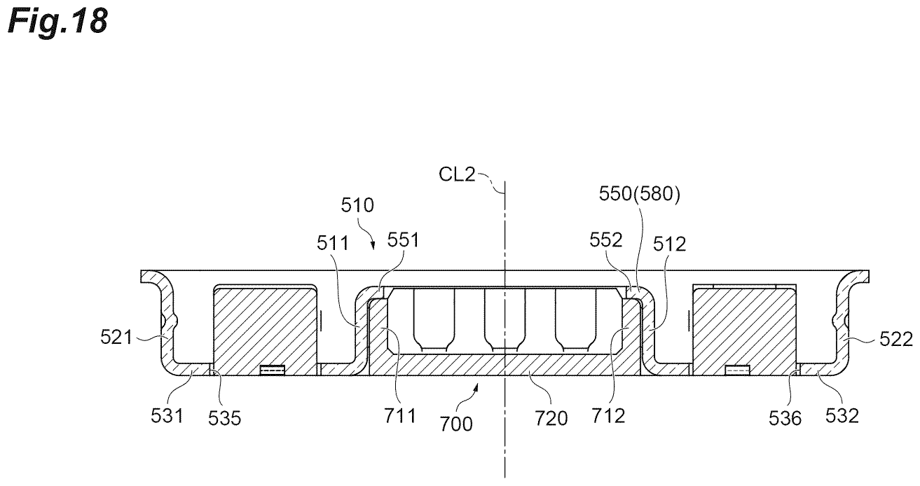

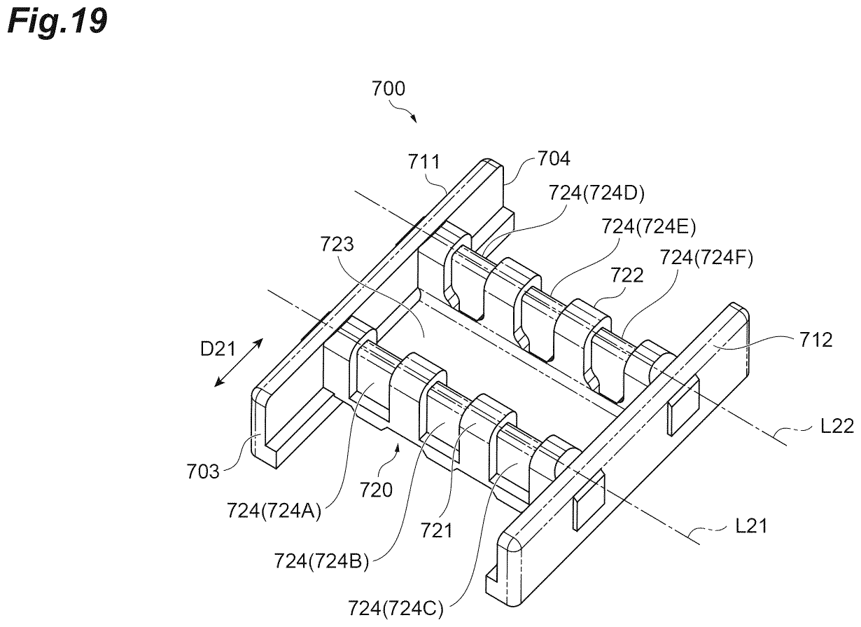

FIG. 19 is a perspective view of the inner housing 700. As illustrated in FIG. 18, the inner housing 700 disposed in the inner surrounding wall 510 is in contact with the second inner end portion 550 in the direction along the axis CL2. For example, the inner housing 700 is in contact with the second inner end portion 551, the second inner end portion 552, the second inner end portion 553, and the second inner end portion 554 within the inner surrounding wall 510.

For example, the inner housing 700 includes a first base portion 711, a second base portion 712, and a contact holding portion 720. The first base portion 711 is in contact with the first partition wall 511. The first base portion 711 spreads in the height direction of the first partition wall 511 with respect to the coupling plate 530 (direction along the axis CL2) and is in contact with the inner surface of the second inner end portion 551 (see FIG. 18). The second base portion 712 is in contact with the second partition wall 512. The second base portion 712 spreads in the height direction of the second partition wall 512 with respect to the coupling plate 530 (direction along the axis CL2) and is in contact with the inner surface of the second inner end portion 552 (see FIG. 18).

As illustrated in FIG. 19, each of the first base portion 711 and the second base portion 712 extends along the contact direction D21. The contact holding portion 720 couples the first base portion 711 to the second base portion 712. The contact holding portion 720 includes a first wall portion 721, a second wall portion 722, and a coupling base 723. The first wall portion 721 couples the first base portion 711 to the second base portion 712 along the row L21. The second wall portion 722 couples the first base portion 711 to the second base portion 712 along the row L22. The coupling base 723 is spread out in a thin plate-like shape along the circuit board 20, couples the first base portion 711 to the second base portion 712, and couples the first wall portion 721 to the second wall portion 722. The first wall portion 721 and the second wall portion 722 rise from the coupling base 723 in a direction away from the circuit board 20.

On the outer surface of the first wall portion 721, recesses 724A, 724B, 724C aligned along the row L21 are formed. The inner contacts 610A, 610B, 610C are respectively accommodated in the recesses 724A, 724B, 724C. On the outer surface of the second wall portion 722, recesses 724D, 724E, 724F aligned along the row L22 are formed. The inner contacts 610D, 610E, 610F are respectively accommodated in the recesses 724D, 724E, 724F.

When the plug connector 3 is connected to the receptacle connector 2, the first wall portion 721 fits into the first groove portion 325 of the contact holding portion 320 and the second wall portion 722 fits into the second groove portion 326 of the contact holding portion 320. The inner contacts 610A, 610B, 610C contact the inner contacts 210A, 210B, 210C in the first groove portion 325, respectively. The inner contacts 610D, 610E, 610F contact the inner contacts 210D, 210E, 210F in the second groove portion 326, respectively.

One end of the first base portion 711 and the second base portion 712 protrudes from the first wall portion 721 toward the first inner side wall 513 and contacts the inner surface of the first inner side wall 513. The first side 703 of the inner housing 700 described above is constituted by the end surfaces of the first base portion 711 and the second base portion 712 that are in contact with the inner surface of the first inner side wall 513. One end of the first base portion 711 and one end of the second base portion 712 form a region that exposes the connecting portion 614 of the inner contacts 610A, 610B, 610C between the third coupling portion 533 (the first inner side wall 513) and the first wall portion 721.

The other end of the first base portion 711 and the second base portion 712 protrudes from the second wall portion 722 toward the second inner side wall 514 and contacts the inner surface of the second inner side wall 514. The second side 704 of the inner housing 700 described above is formed by the end surfaces of the first base portion 711 and the second base portion 712 that are in contact with the inner surface of the second inner side wall 514. The other end of the first base portion 711 and the other end of the second base portion 712 form a region that exposes the connecting portion 614 of the inner contacts 610D, 610E, 610F between the fourth coupling portion 534 (the second inner side wall 514) and the second wall portion 722 (see FIG. 15).

The inner housing 700 is formed by, for example, injection molding of a resin material.

### Outer Housing

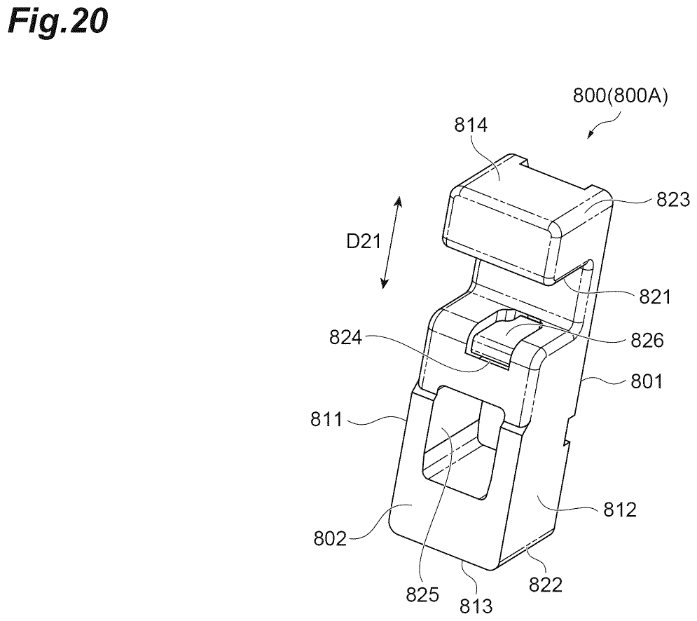

FIG. 20 is a perspective view of the first outer housing 800A. As illustrated in FIG. 20, the first outer housing 800A has a rectangular shape when viewed from the direction along the axis CL1, and includes a first side 811 and a second side 812 that are parallel to each other and a third side 813 and a fourth side 814 that are parallel to each other, in addition to the facing surface 801 and the opposite surface 802 described above. The first outer housing 800A further includes a groove 821. The groove 821 is open to the opposite surface 802 from the first side 811 to the second side 812. By the groove 821, the first outer housing 800A is divided into a first block 822 that constitutes the third side 813, and a second block 823 that constitutes the fourth side 814. Hereinafter, in the inner surfaces of the groove 821, a portion corresponding to the first block 822 is referred to as an “inner surface of the first block 822”, and a portion corresponding to the second block 823 is referred to as an “inner surface of the second block 823”.

In the first block 822, an insertion hole 824 and a through hole 825 aligned along the contact direction D21 are formed. The insertion hole 824 is located between the through hole 825 and the inner surface of the second block 823, and the through hole 825 is located between the insertion hole 824 and the third side 813. The insertion hole 824 is open to the opposite surface 802. The insertion portion 623 of the first outer contact 620A described above is inserted into the insertion hole 824. On the facing surface 801 and the inner surface of the first block 822, a recess 826 continuous to the insertion hole 824 is formed, and the contact portion 621 and the coupling portion 622 of the first outer contact 620A are accommodated in the recess 826. Thus, the contact portion 621 is disposed on the inner surface of the first block 822. The through hole 825 penetrates between the facing surface 801 and the opposite surface 802 and exposes the connecting portion 624 of the first outer contact 620A.

When the plug connector 3 is connected to the receptacle connector 2, the first block 822 fits into the accommodation hole 421 of the first outer housing 400A and the second block 823 fits into the fitting hole 422 of the first outer housing 400A. The contact portion 221 of the first outer contact 220A and the contact portion 621 of the first outer contact 620A are in contact between the partition 423 and the first block 822. By fitting the second block 823 to the fitting hole 422, the position of the first block 822 with respect to the partition 423 is regulated. This increases the reliability of the contact between the contact portion 221 and the contact portion 621.

The second outer housing 800B is substantially the same member as the first outer housing 800A. The relative placement of the second outer contact 620B with respect to the second outer housing 800B is the same as the relative placement of the first outer contact 620A with respect to the first outer housing 800A. Accordingly, a unit combining the second outer housing 800B and the second outer contact 620B is substantially the same unit as a unit combining the first outer housing 800A and the first outer contact 620A.

The first outer housing 800A and the second outer housing 800B are arranged so as to be point-symmetrical to each other when viewed from a direction along the axis CL2. Accordingly, the first outer contact 620A and the second outer contact 620B are point-symmetrical to each other when viewed from the direction along the axis CL2. The above-mentioned first end surface 803 covered by the first outer end wall 521 (see FIG. 15) is formed by the first side 811 of the first outer housing 800A. The above-mentioned second end surface 804 covered by the second outer end wall 522 (see FIG. 15) is formed by the first side 811 of the second outer housing 800B.

Each of the first outer housing 800A and the second outer housing 800B is arranged so as to be separated from the outer surrounding wall 520 and the inner surrounding wall 510 over the entire circumference. For example, in the first outer housing 800A, the first side 811 is separated from the first outer end wall 521, the second side 812 is separated from the first partition wall 511, the third side 813 is separated from the first outer side wall 523, and the fourth side 814 is separated from the second outer side wall 524. In the second outer housing 800B, the first side 811 is separated from the second outer end wall 522, the second side 812 is separated from the second partition wall 512, the third side 813 is separated from the second outer side wall 524, and the fourth side 814 is separated from the first outer side wall 523.

The first outer housing 800A and the second outer housing 800B are formed by, for example, injection molding of a resin material. The first outer housing 800A (the second outer housing 800B) may be integrally formed with the first outer contact 620A (the second outer contact 620B) by insert molding.

### Conductive Pattern of Circuit Board

FIG. 21 is a schematic diagram illustrating the conductive pattern of the circuit board 20. As illustrated in FIG. 21, a ground pattern 21, a plurality of inner signal patterns 22, the first outer signal pattern 23, and the second outer signal pattern 24 are formed on the mounting surface of the circuit board 20. The ground pattern 21 includes the outer ground pattern 25 and the inner ground pattern 26. The inner ground pattern 26 includes the first partition pattern 27 and the second partition pattern 28 that divide the interior of the outer ground pattern 25. The first partition pattern 27 corresponds to the second inner end portion 551 of the first partition wall 511 and the second partition pattern 28 corresponds to the second inner end portion 552 of the second partition wall 512.

The coupling plate 530 is in contact with the outer ground pattern 25 over the entire circumference. In addition, the coupling plate 530 is in contact with the inner ground pattern 26. The coupling plate 530 is electrically connected to the outer ground pattern 25 and the inner ground pattern 26 by soldering or the like.

The plurality of inner signal patterns 22 are arranged between the first partition pattern 27 and the second partition pattern 28 in the outer ground pattern 25. The plurality of inner signal patterns 22 respectively correspond to the plurality of inner contacts 610. The connecting portions 614 of the plurality of inner contacts 610 are in contact with the plurality of inner signal patterns 22, respectively, and are electrically connected to the plurality of inner signal patterns 22, respectively, by soldering or the like. For example, the plurality of inner signal patterns 22 include inner signal patterns 22A, 22B, 22C corresponding to the inner contacts 610A, 610B, 610C and inner signal patterns 22D, 22E, 22F corresponding to the inner contacts 610D, 610E, 610F.

The first outer signal pattern 23 corresponds to the first outer contact 620A. The connecting portion 624 of the first outer contact 620A contacts the first outer signal pattern 23 and is electrically connected to the first outer signal pattern 23 by soldering or the like. The second outer signal pattern 24 corresponds to the second outer contact 620B. The connecting portion 624 of the second outer contact 620B contacts the second outer signal pattern 24 and is electrically connected to the second outer signal pattern 24 by soldering or the like.

In the circuit board 20, the first outer signal pattern 23 and the second outer signal pattern 24 are used to transmit high-frequency signals (for example, RF signals) as compared to signals transmitted by each of the plurality of inner signal patterns 22.

### Description of Assembled State

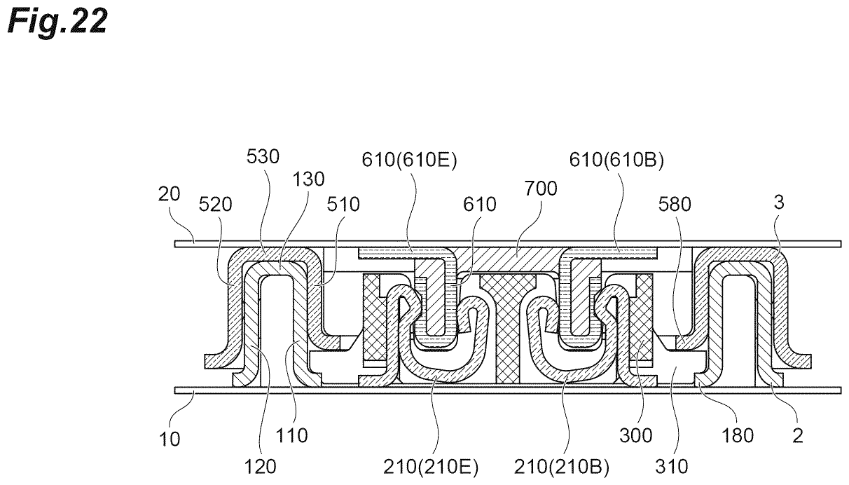

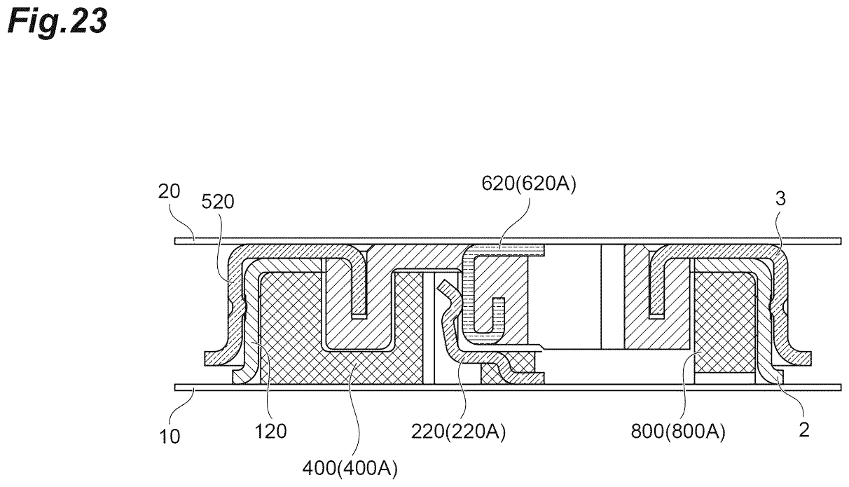

FIGS. 22 and 23 are cross-sectional views illustrating a state in which the plug connector 3 is fitted to the receptacle connector 2. FIG. 22 illustrates a cross-section at the point where the inner contacts 210B, 210E and the inner contacts 610B, 610E are in contact with each other. FIG. 23 illustrates a cross section at the point where the first outer contact 220A and the first outer contact 620A are in contact with each other. As illustrated in FIGS. 22 and 23, when the plug connector 3 is engaged with the receptacle connector 2, the inner surrounding wall 510 is engaged with the inner surrounding wall 110, the outer surrounding wall 520 is engaged with the outer surrounding wall 120, the plurality of inner contacts 610 are respectively in contact with the plurality of inner contacts 210, and the one or more outer contacts 620 are respectively in contact with the one or more outer contacts 220.

Since the inner surrounding wall 510 and the inner surrounding wall 110 fit each other, the first partition wall 111 is disposed between the inner housing 700 and the first outer housing 800A, and the second partition wall 112 is disposed between the inner housing 700 and the second outer housing 800B. Similarly, the first partition wall 511 is disposed between the inner housing 300 and the first outer housing 400A, and the second partition wall 512 is disposed between the inner housing 300 and the second outer housing 400B. The first partition wall 111 and the first partition wall 511 are in contact with each other and are disposed, over the entire height between the circuit board 10 and the circuit board 20, between the inner housing 300 and the inner housing 700 and the first outer housing 400A and the first outer housing 800A. The second partition wall 112 and the second partition wall 512 are in contact with each other and are disposed, over the entire height between the circuit board 10 and the circuit board 20, between the inner housing 300 and the inner housing 700 and the second outer housing 400B and the second outer housing 800B.

For example, the inner surrounding wall 510 is fitted to the inner circumference of the inner surrounding wall 110 and the outer surrounding wall 520 is fitted to the outer circumference of the outer surrounding wall 120. The inner surrounding wall 510 and the inner surrounding wall 110 fitting with each other enclose the plurality of inner contacts 610 and the plurality of inner contacts 210 over the entire height between the circuit board 10 and the circuit board 20. The outer surrounding wall 520 and the outer surrounding wall 120 fitting with each other enclose the inner surrounding wall 510 and the inner surrounding wall 110, and the one or more outer contacts 620 and the one or more outer contacts 220 over the entire height between the circuit board 10 and the circuit board 20.

In a state where the inner surrounding wall 510 and the outer surrounding wall 520 are fitted to the inner surrounding wall 110 and the outer surrounding wall 120, respectively, the coupling plate 130 and the coupling plate 530 overlap each other at a position away from the circuit board 10, and the first plate 180 and the first plate 580 overlap each other at a position away from the circuit board 20.
Between the first plate 180 and the first plate 580, the base portion 310 of the inner housing 300 is disposed.
As described above, a connector 2, 3 is a connector 2, 3 mounted on a circuit board 10, 20 and connected to a mate connector 2, 3 along an axis CL1, CL2 perpendicular to the circuit board 10, 20. The connector 2, 3 includes: a conductive inner surrounding wall 110, 510 surrounding the axis CL1, CL2; a conductive outer surrounding wall 120, 520 surrounding the axis CL1, CL2 and the inner surrounding wall 110, 510; a plurality of conductive inner contacts 210, 610 disposed in the inner surrounding wall 110, 510, electrically connected to the circuit board 10, 20, and contacting a plurality of mate inner contacts 210, 610 of the mate connector 2, 3, respectively; and one or more conductive outer contacts 220, 620 disposed between the inner surrounding wall 110, 510 and the outer surrounding wall 120, 520, electrically connected to the circuit board 10, 20, and in contact with each of one or more mate outer contacts 220, 620 of the mate connector 2, 3, respectively.

By electrically shielding between the one or more outer contacts 220, 620 and the outside of the connector 2, 3 by the outer surrounding wall 120, 520, noise generated in the one or more outer contacts 220, 620 with the outside of the connector 2, 3 as a generation source can be suppressed. By shielding between the plurality of inner contacts 210, 610 and the one or more outer contacts 220, 620, with the inner surrounding wall 110, 510, noise generated in the one or more outer contacts 220, 620, with the plurality of inner contacts 210, 610 as a generation source can be suppressed. Accordingly, the reliability of signal transmission may be improved.

The outer surrounding wall 120, 520 may be seamlessly continuous over an entire circumference. Electrical shielding between the one or more outer contacts 220, 620, and the exterior of the connector 2, 3 can be improved.

The inner surrounding wall 110, 510 may be seamlessly continuous over an entire circumference. Electrical shielding between the plurality of inner contacts 210, 610 and the one or more outer contacts 220, 620 can be improved.

The connectors 2, 3 may further include a conductive coupling plate 130, 530 coupling the inner surrounding wall 110, 510 to the outer surrounding wall 120, 520. The inner surrounding wall 110, 510 and the outer surrounding wall 120, 520 can be handled together as a shell integrated by the coupling plate 130, 530. Accordingly, the production efficiency of the connector 2, 3 can be improved.

The outer surrounding wall 120, 520 may include: a first outer end wall 121, 521 and a second outer end wall 122, 522 parallel to each other; and a first outer side wall 123, 523 and a second outer side wall 124, 524 parallel to each other and respectively couple the first outer end wall 121, 521 to the second outer end wall 122, 522. The one or more outer contacts 220, 620 may include: a first outer contact 220A, 620A disposed between the first outer end wall 121, 521 and the inner surrounding wall 110, 510; and a second outer contact 220B, 620B disposed between the second outer end wall 122, 522 and the inner surrounding wall 110, 510. By disposing the first outer contact 220A, 620A and the second outer contact 220B, 620B away from each other, the noise generated in the second outer contact 220B, 620B with the first outer contact 220A, 620A as a generation source and the noise generated in the first outer contact 220A, 620A with the second outer contact 220B, 620B as a generation source can be further suppressed.

Gaps may be formed between the first outer side wall 123, 523 and the inner surrounding wall 110, 510 and between the second outer side wall 124, 524 and the inner surrounding wall 110, 510. The shell can readily be formed.

Each of the first outer contact 220A, 620A and the second outer contact 220B, 620B may be in contact with a mate outer contact 220, 620 from one direction along a contact direction parallel to the circuit board 10, 20 and the first outer end wall 121, 521. Each of the plurality of inner contacts 210, 610 may be in contact with a mate inner contact 210, 610 from two directions along the contact direction. For example, when a high-frequency signal as compared with the signal transmitted by the inner contact 210, 610 is transmitted by the first outer contact 220A, 620A and the second outer contact 220B, 620B, the generation of noise between each of the first outer contact 220A, 620A and the second outer contact 220B, 620B and the mate outer contact 220, 620 can be further suppressed.

The connector 2, 3 may further include: an insulating inner housing 300, 700 holding the plurality of inner contacts 210, 610 in the inner surrounding wall 110, 510; and an insulating outer housing 400, 800 holding the first outer contact 220A, 620A and the second outer contact 220B, 620B between the outer surrounding wall 120, 520 and the inner surrounding wall 110, 510. The inner housing 300, 700 and the outer housing 400, 800 may be divided by the inner surrounding wall 110, 510. By continuously arranging the inner surrounding wall 110, 510 at the boundary portion between the inner housing 300, 700 and the outer housing 400, 800, the electrical shielding between the plurality of inner contacts 210, 610 and the first outer contact 220A, 620A and the second outer contact 220B, 620B can be improved.

The outer housing 400, 800 may include: a first outer housing 400A, 800A holding the first outer contact 220A, 620A; and a second outer housing 400B, 800B holding the second outer contact 220B, 620B. The first outer housing 400A, 800A and the second outer housing 400B, 800B may be divided by the inner surrounding wall 110, 510. The electrical shielding between the first outer contact 220A, 620A and the second outer contact 220B, 620B can be further improved.

The inner surrounding wall 110 may include: a first inner end portion 140 close to the circuit board 10; and a second inner end portion 150 spaced apart from the circuit board 10. The outer surrounding wall 120 may include: a first outer end portion 160 close to the circuit board 10 and a second outer end portion 170 spaced apart from the circuit board 10. The coupling plate 130 may couple the second inner end portion 150 to the second outer end portion 170. The mate connector 3 may readily be guided to the fitting position by sliding the mate connector 3 along the coupling plate 130.

A first opening 135 that exposes the first outer contact 220A and a second opening 136 that exposes the second outer contact 220B may be formed in the coupling plate 130. Each of the first outer contact 220A and the second outer contact 220B can readily be brought into contact with a mate outer contact 620 while improving the production efficiency by integrating the inner surrounding wall 110 and the outer surrounding wall 120 with the coupling plate 130.

The first inner end portion 140 and the first outer end portion 160 may be in contact with a conductive pattern of the circuit board 10. The shielding between the plurality of inner contacts 210 and the first outer contact 220A and the second outer contact 220B and the electrical shielding between the first outer contact 220A and the second outer contact 220B and the outside of the connector 2 can be further improved.

The first inner end portion 140 may be bent toward the inside of the inner surrounding wall 110 over an entire circumference. The first outer end portion 160 may be bent toward the outside of the outer surrounding wall 120 over an entire circumference. A margin for connection to the circuit board 10 can be increased and mounting workability of the connector 2 to the circuit board 10 can be improved.

The inner housing 300 may be in contact with the first inner end portion 140 in a direction along the axis CL1. The first inner end portion 140 bent toward the inside of the inner surrounding wall 110 can be utilized for positioning of the inner housing 300.

The inner housing 300 may include: a base portion 310 in contact with the first inner end portion 140 in the direction along the axis CL1; and the contact holding portion 320 protruding from the base portion 310 in a direction away from the circuit board 10 and holding the plurality of inner contacts 210. A gap may be formed between the contact holding portion 320 and the inner surrounding wall 110 over an entire circumference. For example, a space for inserting a mate inner surrounding wall 510 of the mate connector 3 can be secured in the inner surrounding wall 110. Thus, the inner surrounding wall 110 and the mate inner surrounding wall 510 can be fitted to each other, and the shielding property between the plurality of inner contacts 210 and the first outer contact 220A and the second outer contact 220B can be further improved.

The inner surrounding wall 510 may include: a first inner end portion 540 close to the circuit board 20; and a second inner end portion 550 spaced apart from the circuit board 20. The outer surrounding wall 520 may include: the first outer end portion 560 close to the circuit board 20 and the second outer end portion 570 spaced apart from the circuit board 20. The coupling plate 530 may couple the first inner end portion 540 to the first outer end portion 560. A mate connector 2 can be accepted between the inner surrounding wall 510 and the outer surrounding wall 520, while integrating the inner surrounding wall 510 and the outer surrounding wall 520 with the coupling plate 530 to improve production efficiency.

A first opening 535 that exposes the first outer contact 620A and a second opening 536 that exposes the second outer contact 620B may be formed in the coupling plate 530. Each of the first outer contact 620A and the second outer contact 620B can readily be connected to the circuit board 20 while integrating the inner surrounding wall 510 and the outer surrounding wall 520 with the coupling plate 530 to improve production efficiency.

The coupling plate 530 may be in contact with a conductive pattern of the circuit board 20. The coupling plate 530 can be utilized as a connecting portion to the conductive pattern and the attachment workability of the connector 3 to the circuit board 20 can be improved.

The second inner end portion 550 may be bent toward the inside of the inner surrounding wall 510 over an entire circumference. The second outer end portion 570 may be bent toward the outside of the outer surrounding wall 520 over an entire circumference. The mate connector 2 can be smoothly introduced between the inner surrounding wall 510 and the outer surrounding wall 520.

In the inner surrounding wall 510, the inner housing 700 may be in contact with the second inner end portion 550. The second inner end portion 550 bent toward the inside of the inner surrounding wall 510 can be utilized for positioning of the inner housing 700.

A height of the inner surrounding wall 510 with respect to the coupling plate 530 may be lower than a height of the outer surrounding wall 520 with respect to the coupling plate 530. By reducing the height of the inner surrounding wall 510, a space for disposing a mate inner housing 300 of the mate connector 2 or the like can be secured.

Each of the first outer housing 800A and the second outer housing 800B may be spaced apart from the outer surrounding wall 520 and the inner surrounding wall 510 over an entire circumference. Between the inner surrounding wall 510 and the outer surrounding wall 520, for example, an insertion space for the mate inner surrounding wall 110 and the mate outer surrounding wall 120 of the mate connector 2 can be secured. Thus, the inner surrounding wall 510 and the mate inner surrounding wall 110 are fitted to each other, and the outer surrounding wall 520 and the mate outer surrounding wall 120 are fitted to each other, so that the electrical shielding between the plurality of inner contacts 610 and the first outer contact 620A and the second outer contact 620B, and the electrical shielding between the first outer contact 620A and the second outer contact 620B and the outside of the connector 3 can be further improved.

The coupling plate 530 may be formed with; one or more first anchors 591 inserted into the first outer housing 800A; and one or more second anchors 592 inserted into the second outer housing 800B. The fixing strength of the first outer housing 800A and the second outer housing 800B to the coupling plate 530 can be improved.

The connector system 1 includes: a mate connector 2 mounted on a mate circuit board 10; and a connector 3 mounted on a circuit board 20 and configured to be connected to the mate connector 2 along an axis CL2 perpendicular to the mate circuit board 10 and the circuit board 20. The mate connector 2 includes: a mate inner surrounding wall 110 surrounding the axis CL2; a mate outer surrounding wall 120 surrounding the axis CL2 and the mate inner surrounding wall 110; a plurality of mate inner contacts 210 disposed in the mate inner surrounding wall 110 and electrically connected to the mate circuit board 10; and one or more mate outer contacts 220 disposed between the mate inner surrounding wall 110 and the mate outer surrounding wall 120 and electrically connected to the mate circuit board 10. The connector 3 includes: an inner surrounding wall 510 surrounding the axis CL2 and configured to fit to the mate inner surrounding wall 110; an outer surrounding wall 520 surrounding the axis CL2 and the inner surrounding wall 510 and configured to fit to the mate outer surrounding wall 120; a plurality of inner contacts 610 disposed in the inner surrounding wall 510, electrically connected to the circuit board 20, and configured to be in contact with each of the plurality of mate inner contacts 210, respectively; and one or more outer contacts 620 disposed between the inner surrounding wall 510 and the outer surrounding wall 520, electrically connected to the circuit board 20, and configured to be in contact with each of the one or more mate outer contacts 220, respectively

The inner surrounding wall 510 may be configured to fit to an inner circumference of the mate inner surrounding wall 110. The outer surrounding wall 520 may be configured to fit to the outer circumference of the mate outer surrounding wall 120.

The mate inner surrounding wall 110 and the inner surrounding wall 510 fitted with each other may surround the plurality of mate inner contacts 210 and the plurality of inner contacts 610 over an entire height between the circuit board 20 and the mate circuit board 10. The mate outer surrounding wall 120 and the outer surrounding wall 520 fitted to each other may surround the mate inner surrounding wall 110 and the inner surrounding wall 510 and the one or more mate outer contacts 220 and the one or more outer contacts 620 over an entire height between the circuit board 20 and the mate circuit board 10. Electrical shielding between the plurality of inner contacts 610 and the plurality of mate inner contacts 210 and the one or more outer contacts 620 and the one or more mate outer contacts 220 can be improved by cooperation of the inner surrounding wall 510 and the mate inner surrounding wall 110. Electrical shielding between the one or more outer contacts 620 and the one or more mate outer contacts 220 and the outside of the connector 3 can be improved by the cooperation of the outer surrounding wall 520 and the mate outer surrounding wall 120.

The mate inner surrounding wall 110 may include: a mate first inner end portion 140 close to the mate circuit board 10; and a mate second inner end portion 150 spaced apart from the mate circuit board 10. The mate outer surrounding wall 120 may include: a mate first outer end portion 160 close to the mate circuit board 10; and a mate second outer end portion 170 spaced apart from the mate circuit board 10. The inner surrounding wall 510 may include: a first inner end portion 540 close to the circuit board 20; and a second inner end portion 550 spaced apart from the circuit board 20. The outer surrounding wall 520 may include: a first outer end portion 560 close to the circuit board 20 and a second outer end portion 570 spaced apart from the circuit board 20. The mate connector 2 may further include a conductive mate coupling plate 130 facing the mate circuit board 10 and coupling the mate second inner end portion 150 to the mate second outer end portion 170. The connector 3 may further include a conductive coupling plate 530 facing the circuit board 20 and coupling the first inner end portion 540 to the first outer end portion 560. In a state where the inner surrounding wall 510 and the outer surrounding wall 520 are fitted to the mate inner surrounding wall 110 and the mate outer surrounding wall 120, respectively, the coupling plate 530 and the mate coupling plate 130 may overlap at a position spaced apart from the mate circuit board 10. Utilizing the mate coupling plate 130 as a guide, the mate inner surrounding wall 110 and the mate outer surrounding wall 120 can be smoothly introduced between the inner surrounding wall 510 and the outer surrounding wall 520.

The mate connector 2 may further include an insulating mate inner housing 300 that holds the plurality of mate inner contacts 210 in the mate inner surrounding wall 110. A height of the mate inner surrounding wall 110 with respect to the mate coupling plate 130 may be equal to the height of the mate outer surrounding wall 120 with respect to the mate coupling plate 130. A height of the inner surrounding wall 510 with respect to the coupling plate 530 may be lower than a height of the outer surrounding wall 520 with respect to the coupling plate 530. By reducing the height of the inner surrounding wall 510, a space for disposing the mate inner housing 300 can readily be secured.

A connector 2, 3 is a connector 2, 3 mounted on a circuit board 10, 20 and connected to a mate connector 2, 3 along an axis perpendicular to the circuit board 10, 20. The connector 2, 3 includes: a plurality of conductive first contacts 210, 610 electrically connected to the circuit board 10, 20 and respectively contacting a plurality of mate first contacts 210, 610 of the mate connector 2, 3; a conductive second contact 220A, 620A electrically connected to the circuit board 10, 20 and contacting a mate second contact 220A, 620A of the mate connector 2, 3; an insulative first housing 300, 700 holding the plurality of first contacts 210, 610; an insulative second housing 400A, 800A formed separately from the first housing 300, 700 and holding the second contact 220A, 620A; and a conductive first partition wall 111, 511 disposed between the first housing 300, 700 and the second housing 400A, 800A.

Since the second housing 400A, 800A is formed separately from the first housing 300, 700, the first partition wall 111, 511 can readily be disposed between the first housing 300, 700 and the second housing 400A, 800A. Accordingly, an electrical shielding between the plurality of first contacts 210, 610 and the second contact 220A, 620A can be improved and noise generated in the second contact 220A, 620A with the plurality of first contacts 210, 610 as a generation source can be suppressed. Therefore, the reliability of signal transmission may be improved.

The connectors 2, 3 may further include: a conductive third contact 220B, 620B electrically connected to the circuit board 10, 20 and configured to come into contact with a mate third contact 220B, 620B of the mate connector 2, 3; an insulating third housing 400B, 800B formed separately from the first housing 300, 700 and holding the third contact 220B, 620B; and a conductive second partition wall 112, 512 disposed between the first housing 300, 700 and the third housing 400B, 800B. The first housing 300, 700 may be located between the second housing 400A, 800A and the third housing 400B, 800B when viewed from a direction along the axis. Since the third housing 400B, 800B is formed separately from the first housing 300, 700, the second partition wall 112, 512 can readily be disposed between the first housing 300, 700 and the third housing 400B, 800B. Accordingly, an electrical shielding between the plurality of first contacts 210, 610 and the third contact 220B, 620B can be improved and noise generated in the third contact 220B, 620B with the plurality of first contacts 210, 610 as a generation source can be suppressed. Furthermore, the electrical shielding between the second contact 220A, 620A and the third contact 220B, 620B can be improved.

The second housing 400A, 800A and the third housing 400B, 800B may be point-symmetric to each other when viewed from the direction along the axis. The components of the second housing 400A, 800A and the third housing 400B, 800B can be standardized and the production efficiency of the connector 2, 3 can be improved.

Each of the second contact 220A, 620A and the third contact 220B, 620B may be in contact with the mate second contact 220A, 620A and the mate third contact 220B, 620B, respectively, from one direction along a contact direction parallel to the circuit board 10, 20. Each of the plurality of first contacts 210, 610 may be in contact with the mate first contact 210, 610 from two directions along the contact direction. The generation of noise between each of the second contact 220A, 620A and the third contact 220B, 620B and the mate contact can be further suppressed in a case where the signal of high-frequency compared to the signal transmitted by the first contact 210, 610 is transmitted by the second contact 220A, 620A and the third contact 220B, 620B.

The first housing 300, 700 may include a first side 303, 703 and a second side 304, 704 parallel to a plane that intersects both the circuit board 10, 20 and the first partition wall 111, 511. Each of the first partition wall 111, 511 and the second partition wall 112, 512 may extend from the first side 303, 703 toward the second side 304, 704. Electric shielding between the plurality of first contacts 210, 610 and the second contact 220A, 620A and electric shielding between the plurality of first contacts 210, 610 and the third contact 220B, 620B can be improved.

The second housings 400A, 800A may include a first end surface 403, 803 facing away from the first partition walls 111, 511. The third housing 400B, 800B may include a second end surface 404, 804 facing away from the second partition walls 112, 512. The connector 2, 3 may further include: a conductive first end wall 121, 521 covering the first end surface 403, 803; and a conductive second end wall 122, 522 covering the second end surface 404, 804. Electric shielding between the second contact 220A, 620A and the outside of the connector 2, 3 and electric shielding between the third contact 220B, 620B and the outside of the connector 2, 3 can be improved.

The connectors 2, 3 may further include: a conductive first plate 180, 580 coupling the first partition wall 111, 511 to the second partition wall 112, 512; a conductive second plate 131, 531 coupling the first end wall 121, 521 to the first partition wall 111, 511; and a conductive third plate 132, 532 coupling the second end wall 122, 522 to the second partition wall 112, 512. The first end wall 121, 521, the first partition wall 111, 511, the second partition wall 112, 512 and the second end wall 122, 522 can be handled together as a shell integrated by the first plate 180, 580, the second plate 131, 531 and the second coupling portion 132, 532. Accordingly, the production efficiency of the connector 2, 3 can be improved.

Each of the first housing 300, the second housing 400A, and the third housing 400B may have a facing surface facing the circuit board 10 and an opposite surface of the facing surface. The first plate 180 may cover the facing surface of the first housing 300. The second plate 131 may cover the opposite surface of the second housing 400A. The third plate 132 may cover the opposite surface of the third housing 400B. The mate connector 3 can be slid along the second plate 131 and the third plate 132, and the mate connector 3 can readily be guided to the fitting position.

A first opening 181 that exposes the plurality of first contacts 210 may be formed in the first plate 180. A second opening 135 that exposes the second contact 220A may be formed in the second plate 131. A third opening 136 that exposes the third contact 220B may be formed in the third plate 132. The first plate 180, the second plate 131, and the third plate 132 allow each of the second contact 220A and the third contact 220B to readily contact the mate contact while integrating a first end wall 121, the first partition wall 111, the second partition wall 112, and a second end wall 122 to improve manufacturing efficiencies.

The first plate 180 may contact the conductive pattern of the circuit board 10. By utilizing the first plate 180 as a connecting portion to the conductive pattern, the attachment workability of the connector 2 to the circuit board 10 may be improved.

The first housing 300 may include a base portion 310 that is in contact with the first plate 180 and a contact holding portion 320 that protrudes from the base portion 310 in a direction away from the circuit board 10 and holds the plurality of first contacts 210, and gaps may be formed between each of the first partition wall 111 and the second partition wall 112 and the contact holding portion 320. The insertion space of a mate first partition wall 511 can be secured between the first partition wall 111 and the contact holding portion 320, and the insertion space of a mate second partition wall 512 can be secured between the second partition wall 112 and the contact holding portion 320. The cooperation of the first partition wall 111 and the mate first partition wall 511 and the cooperation of the second partition wall 112 and the mate second partition wall 512 can further improve the electrical shielding between the plurality of first contacts 210 and the second contact 220A and the third contact 220B.

Each of the first housing 700, the second housing 800A, and the third housing 800B may include a facing surface facing the circuit board 20 and an opposite surface of the facing surface. The first plate 580 may cover the opposite surface of the first housing 700. The second plate 531 may cover the facing surface of the second housing 800A. The third plate 532 may cover the facing surface of the third housing 800B. The first plate 580, the second plate 531, and the third plate 532 allow the mate connector 2 to be accepted between the first end wall 521 and the first partition wall 511 and between the second end wall 522 and the second partition wall 512, while integrating the first end wall 521, the first partition wall 511, the second partition wall 512, and the second end wall 522 to improve production efficiency.

A first opening 581 that exposes the plurality of first contacts 610 may be formed in the first plate 580. A second opening 535 that exposes the second contact 620A may be formed in the second plate 531. A third opening 536 that exposes the third contact 620B may be formed in the third plate 532. Each of the second contact 620A and the third contact 620B can readily be connected to the circuit board 20 while the first end wall 521, the first partition wall 511, the second partition wall 512, and the second end wall 522 are integrated by the first plate 580, the second plate 531, and the third plate 532 to improve production efficiency.

Each of the second plate 531 and the third plate 532 may contact a conductive pattern of the circuit board 20. By utilizing the second plate 531 and the third plate 532 as connecting portions to the conductive pattern, the workability of attaching the connector 3 to the circuit board 20 may be improved.

Gaps may be formed between the second housing 800A and each of the first end wall 521 and the first partition wall 511. Gaps may be formed between the third housing 800B and each of the second end wall 522 and the second partition wall 512. The insertion space of a mate first partition wall 111 can be secured between the first partition wall 511 and the second housing 800A, and the insertion space of a mate first end wall 121 can be secured between the first end wall 521 and the second housing 800A. The insertion space of a mate second partition wall 112 can be secured between the second partition wall 512 and the third housing 800B, and the insertion space of a mate second end wall 122 can be secured between the second end wall 522 and the third housing 800B. The cooperation of the first partition wall 511 and the mate first partition wall 111 and the cooperation of the second partition wall 512 and the mate second partition wall 112 can further improve the electrical shielding between the plurality of first contacts 610 and the second contact 620A and the third contact 620B. The cooperation of the first end wall 521 and the mate first end wall 121 can further improve the electrical shielding between the second contact 620A and the outside of the connector 3. The cooperation of the second end wall 522 and the mate second end wall 122 can further improve the electrical shielding between the third contact 620B and the outside of the connector 3.

The first anchor 591 inserted into the second housing 800A may be formed in the second plate 531, and the second anchor 592 inserted into the third housing 800B may be formed in the third plate 532. The fixing strength of the second housing 800A to the second plate 531 and the fixing strength of the third housing 800B to the third plate 532 can be improved.

A connector system 1 includes: a connector 2 connected to the circuit board 10; and a mate connector 3 connected to a mate circuit board 20. The mate connector 3 includes: a plurality of conductive mate first contacts 610 electrically connected to the mate circuit board 20; a conductive mate second contact 620A electrically connected to the mate circuit board 20; an insulating mate first housing 700 holding the plurality of mate first contacts 610; and an insulating mate second housing 800A formed separately from the mate first housing 700 and holding the mate second contact 620A. The connector 2 includes: a plurality of conductive first contacts 210 electrically connected to the circuit board 10; a conductive second contact 220A electrically connected to the circuit board 10; an insulating first housing 300 holding the plurality of first contacts 210 and configured to be fitted to the mate first housing 700; an insulating second housing 400A formed separately from the first housing 300, holding the second contact 220A, and fitted to the mate second housing 800A; and a conductive partition wall disposed between the first housing 300 and the second housing 400A. In a state in which the first housing 300 is fitted to the mate first housing 700 and the second housing 400A is fitted to the mate second housing 800A, the plurality of first contacts 210 are in contact with the plurality of mate first contacts 610, respectively, the second contact 220A is in contact with the mate second contact 620A, and the partition wall is disposed between the mate first housing 700 and the mate second housing 800A.

The mate connector 3 may further include a conductive mate partition wall disposed between the mate first housing 700 and the mate second housing 800A. In a state where the first housing 300 is fitted to the mate first housing 700 and the second housing 400A is fitted to the mate second housing 800A, the partition wall and the mate partition wall may be in contact with each other and may be disposed between the first housing 300 and the mate first housing 700 and between the second housing 400A and the mate second housing 800A over the entire height between the circuit board 10 and the mate circuit board 20. Cooperation of the first partition wall 111 and the mate first partition wall 511 can further improve the electrical shielding between the plurality of first contacts 210 and the second contact 220A.

Each of the mate first housing 700 and the mate second housing 800A may include a facing surface facing the mate circuit board 20 and an opposite surface of the facing surface. The mate connector 3 may include: a conductive mate first plate 580 covering the opposite surface of the mate first housing 700; and a conductive mate second plate 531 covering the facing surface of the mate second housing 800A. The mate partition wall may couple the mate first plate 580 to the mate second plate 531. Each of the first housing 300 and the second housing 400A may include a facing surface facing the circuit board 10 and an opposite surface of the facing surface. The connector 2 may include: a conductive first plate 180 covering the facing surface of the first housing 300; and a conductive second plate 131 covering the opposite surface of the second housing 400A. The partition wall may couple the first plate 180 to the second plate 131. In a state where the first housing 300 is fitted to the mate first housing 700 and the second housing 400A is fitted to the mate second housing 800A, the first plate 180 and the mate first plate 580 may overlap each other at a position away from the mate circuit board 20, and the second plate 131 and the mate second plate 531 may overlap each other at a position away from the circuit board 10. The mate first housing 700 can be smoothly fitted to the first housing 300 by using the mate first plate 580 as a guide, and the second housing 400A can be smoothly fitted to the mate second housing 800A by using the second plate 131 as a guide.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A connector configured to be mounted on a circuit board and to be connected to a mate connector along an axis perpendicular to the circuit board, the connector comprising:
a conductive inner surrounding wall surrounding the axis;
a conductive outer surrounding wall surrounding the axis and the inner surrounding wall;
a plurality of conductive inner contacts disposed in the inner surrounding wall, configured to be electrically connected to the circuit board, and configured to be respectively in contact with a plurality of mate inner contacts of the mate connector; and
one or more conductive outer contacts disposed between the inner surrounding wall and the outer surrounding wall, configured to be electrically connected to the circuit board, and configured to be respectively in contact with one or more mate outer contacts of the mate connector.

2. The connector according to claim 1, wherein the outer surrounding wall is seamlessly continuous over an entire circumference.

3. The connector according to claim 1, wherein the inner surrounding wall is seamlessly continuous over an entire circumference.

4. The connector according to claim 1, further comprising a conductive coupling plate coupling the inner surrounding wall to the outer surrounding wall.

5. The connector according to claim 4, wherein the outer surrounding wall comprises:
a first outer end wall and a second outer end wall parallel to each other; and
a first outer side wall and a second outer side wall parallel to each other, wherein each of the first outer side wall and the second outer side wall couples the first outer end wall to the second outer end wall,
wherein the one or more outer contacts comprise:
a first outer contact disposed between the first outer end wall and the inner surrounding wall; and
a second outer contact disposed between the second outer end wall and the inner surrounding wall.

6. The connector according to claim 5, wherein a first gap is formed between the first outer side wall and the inner surrounding wall, and
wherein a second gap is formed between the second outer side wall and the inner surrounding wall.

7. The connector according to claim 5, wherein each of the first outer contact and the second outer contact is in contact with a mate outer contact from one direction along a contact orientation parallel to the circuit board and the first outer end wall, and
wherein each of the plurality of inner contacts is in contact with a mate inner contact from two opposite directions along the contact orientation.

8. The connector according to claim 5, further comprising:
an insulating inner housing that holds the plurality of inner contacts in the inner surrounding wall; and
an insulative outer housing that holds the first outer contact and the second outer contact between the outer surrounding wall and the inner surrounding wall,
wherein the inner housing and the outer housing are divided by the inner surrounding wall.

9. The connector according to claim 8, wherein the outer housing comprises:
a first outer housing that holds the first outer contact; and
a second outer housing that holds the second outer contact,
wherein the first outer housing and the second outer housing are divided by the inner surrounding wall.

10. The connector according to claim 9, wherein the inner surrounding wall comprises a first inner end portion and a second inner end portion,
wherein the outer surrounding wall comprises a first outer end portion and a second outer end portion,
wherein the first inner end portion and the first outer end portion are located closer to the circuit board than the second inner end portion and the second outer end portion when the connector is mounted on the circuit board, and
wherein the coupling plate couples the second inner end portion to the second outer end portion.

11. The connector according to claim 10, wherein a first opening that exposes the first outer contact and a second opening that exposes the second outer contact are formed in the coupling plate.

12. The connector according to claim 11, wherein the first inner end portion and the first outer end portion are in contact with a conductive pattern of the circuit board when the connector is mounted on the circuit board.

13. The connector according to claim 11, wherein the first inner end portion is bent toward the axis over an entire circumference, and
wherein the first outer end portion is bent away from the axis over an entire circumference.

14. The connector according to claim 13, wherein the inner housing is in contact with the first inner end portion in an orientation along the axis.

15. The connector according to claim 14, wherein the inner housing comprises:
a base portion in contact with the first inner end portion in the orientation along the axis; and
a contact holding portion protruding from the base portion toward a direction away from the first inner end portion along the axis and holding the plurality of inner contacts,
wherein a gap is formed between the contact holding portion and the inner surrounding wall over an entire circumference.

16. The connector according to claim 9, wherein the inner surrounding wall comprises a first inner end portion and a second inner end portion,
wherein the outer surrounding wall comprises a first outer end portion and a second outer end portion,
wherein the first inner end portion and the first outer end portion are located closer to the circuit board than the second inner end portion and the second outer end portion when the connector is mounted on the circuit board, and
wherein the coupling plate couples the first inner end portion to the first outer end portion.

17. The connector according to claim 16, wherein a first opening that exposes the first outer contact and a second opening that exposes the second outer contact are formed in the coupling plate.

18. The connector according to claim 16, wherein the coupling plate is in contact with a conductive pattern of the circuit board when the connector is mounted on the circuit board.

19. The connector according to claim 16, wherein the second inner end portion is bent toward the axis over an entire circumference, and
wherein the second outer end portion is bent away from the axis over an entire circumference.

20. The connector according to claim 19, wherein, in the inner surrounding wall, the inner housing is in contact with the second inner end portion.

21. The connector according to claim 16, wherein a height of the inner surrounding wall with respect to the coupling plate is lower than a height of the outer surrounding wall with respect to the coupling plate.

22. The connector according to claim 16, wherein each of the first outer housing and the second outer housing is spaced apart from the outer surrounding wall and the inner surrounding wall over an entire circumference.

23. The connector according to claim 22, wherein the coupling plate comprises:
one or more first anchors inserted into the first outer housing; and
one or more second anchors inserted into the second outer housing.

24. A connector system, comprising:
a mate connector configured to be mounted on a mate circuit board; and
a connector configured to be mounted on a circuit board and configured to be connected to the mate connector along an axis perpendicular to the mate circuit board and the circuit board;
wherein the mate connector comprises:
a conductive mate inner surrounding wall surrounding the axis;
a conductive mate outer surrounding wall surrounding the axis and the mate inner surrounding wall;
a plurality of conductive mate inner contacts disposed in the mate inner surrounding wall and configured to be electrically connected to the mate circuit board; and
one or more conductive mate outer contacts disposed between the mate inner surrounding wall and the mate outer surrounding wall and configured to be electrically connected to the mate circuit board, and
wherein the connector comprises:
a conductive inner surrounding wall surrounding the axis and configured to fit to the mate inner surrounding wall;
a conductive outer surrounding wall surrounding the axis and the inner surrounding wall and configured to fit to the mate outer surrounding wall;
a plurality of conductive inner contacts disposed in the inner surrounding wall, configured to be electrically connected to the circuit board, and configured to be respectively in contact with the plurality of mate inner contacts; and
one or more outer contacts disposed between the inner surrounding wall and the outer surrounding wall, configured to be electrically connected to the circuit board, and configured to be respectively in contact with the one or more mate outer contacts.

25. The connector system according to claim 24, wherein the inner surrounding wall is configured to fit to an inner circumference of the mate inner surrounding wall, and
wherein the outer surrounding wall is configured to fit to an outer circumference of the mate outer surrounding wall.

26. The connector system according to claim 25, wherein the mate inner surrounding wall and the inner surrounding wall fitted to each other surround the plurality of mate inner contacts and the plurality of inner contacts over an entire height between the circuit board and the mate circuit board, and
wherein the mate outer surrounding wall and the outer surrounding wall fitted to each other surround the mate inner surrounding wall, the inner surrounding wall, the one or more mate outer contacts, and the one or more outer contacts over an entire height between the circuit board and the mate circuit board.

27. The connector system according to claim 25, wherein the mate inner surrounding wall comprises a mate first inner end portion and a mate second inner end portion,
wherein the mate outer surrounding wall comprises a mate first outer end portion and a mate second outer end portion,
wherein the mate first inner end portion and the mate first outer end portion are located closer to the mate circuit board than the mate second inner end portion and the mate second outer end portion when the mate connector is mounted on the mate circuit board
wherein the inner surrounding wall comprises a first inner end portion and a second inner end portion,
wherein the outer surrounding wall comprises a first outer end portion and a second outer end portion,
wherein the first inner end portion and the first outer end portion are located closer to the circuit board than the second inner end portion and the second outer end portion when the connector is mounted on the circuit board
wherein the mate connector further comprises a conductive mate coupling plate configured to face the mate circuit board and coupling the mate second inner end portion to the mate second outer end portion,
wherein the connector further comprises a conductive coupling plate configured to face the circuit board and coupling the first inner end portion to the first outer end portion, and
wherein, when the inner surrounding wall and the outer surrounding wall are respectively fitted to the mate inner surrounding wall and the mate outer surrounding wall, the coupling plate and the mate coupling plate overlap each other.

28. The connector system according to claim 27, wherein the mate connector further comprises an insulating mate inner housing that holds the plurality of mate inner contacts in the mate inner surrounding wall,
wherein a height of the mate inner surrounding wall with respect to the mate coupling plate is equal to a height of the mate outer surrounding wall with respect to the mate coupling plate, and
wherein a height of the inner surrounding wall with respect to the coupling plate is lower than a height of the outer surrounding wall with respect to the coupling plate.
